(19) United States
(12) Patent Application Publication
(10) Pub. No.: US 2026/0309541 A1
(43) Pub. Date: Oct. 8, 2026

(54) CONFIGURABLE MOBILE DEVICE PROCESSING CELL

(71) Applicant: Apkudo, Inc., Baltimore, MD (US)

(72) Inventor: Axel Schneider, Grossenwiehe (DE)

(21) Appl. No.: 19/634,630

(22) Filed: Mar. 31, 2026

Related U.S. Application Data
(60) Provisional application No. 63/783,696, filed on Apr. 4, 2025.

(51) Int. Cl. G01H 1/00

(52) U.S. Cl. CPC G01H 1/00

(57) ABSTRACT

An automated mobile device processing system streamlines the inspection, testing, and grading of mobile devices. The system comprises a plurality of inspection and testing cells arranged in a serial configuration, with each cell including an integrated conveyor segment that enables devices to be transported between cells without external conveyance equipment. A load manager coordinates device distribution across the cells and controls conveyor operations to optimize throughput. Each cell includes testing modules for cosmetic inspection, display inspection, camera inspection, audio inspection, and wired communication testing. A vibration testing apparatus includes a panel with a cutout, a membrane stretched across the cutout for receiving a mobile device, and a sensor attached to the membrane for detecting vibrations transmitted through the membrane when the mobile device vibrates. A predictive maintenance system monitors component status and generates maintenance alerts.

### CROSS-REFERENCE TO RELATED APPLICATIONS

This application claims priority to U.S. Provisional Application No. 63/783,696, titled “CONFIGURABLE MOBILE DEVICE PROCESSING CELL”, filed Apr. 4, 2025, which is hereby incorporated by reference in its entirety.

### FIELD OF INVENTION

The present disclosure relates to automated mobile device processing systems, and more particularly to a configurable processing cell with integrated conveyance for performing inspection, testing, and grading of mobile devices.

### BACKGROUND

Mobile devices, such as cell phones, have become ubiquitous tools for communication, productivity, and entertainment. Advancements in hardware and software technologies significantly enhanced the capabilities of these devices.

The lifecycle of mobile devices is often limited by rapid advancements in technology and shifting consumer preferences. Manufacturers routinely release new models, leading to frequent device upgrades by users. Older devices, while often still functional, are commonly replaced. Many of these devices are resold and reused in secondary markets, or they are repurposed for other applications.

The reuse of mobile devices is gaining importance as a practical and economic measure, allowing users and organizations to extract additional value from existing technology and reducing environmental electronic waste. Used mobile devices often find new life through resale or redistribution to users in different markets, including emerging economies. Such practices extend the usability of devices, helping bridge technological gaps and providing access to communication and digital services for a broader population.

### SUMMARY

The present disclosure generally relates to an automated mobile device processing system that streamlines the inspection, repair, and grading of mobile devices. An example system comprises one or more inspection and testing cells, within which are contained the necessary testing apparatuses for performing different tasks such as cosmetic inspection, display inspection, camera inspection, audio inspection, USB testing, and among others.

For example, with respect to cosmetic inspection, the cells may employ various imaging and AI (artificial intelligence)-based defect detection to identify physical defects. Display inspection may assess the functionality of the device’s display. Camera inspection may determine the performance of the device’s cameras under various lighting conditions. Audio inspection may evaluate audio components of the mobile device. USB testing may determine the functionality of various ports and perform tests across different device modes

Moreover, the automated mobile device processing system of the present disclosure has been improved to process a wider variety of devices, such as tablets, flip phones, and foldable phones, without requiring a mechanical retrofitting, manual re-configuration of the system, or software re-configuration. Conventional systems may struggle with these devices due to their differences in size, structure, and moving or detachable components, such as a hinged cover or a detachable stylus. The mobile device processing system is thus configured to process bar phones, flip phones, foldable phones, and tablets in a product mix without mechanical retrofitting, manual re-configuration, or software re-configuration.

An aspect of the system uses a predictive maintenance system that monitors the status and performance of each testing apparatus. The predictive maintenance system may generate alerts for maintenance requirements, such as refilling a consumable within the system or alerting when there is an error, such as when a component needs to be replaced, repaired, or cleaned, for example.

Another aspect of the system employs an integrated mobile device application. The application may be executed from the mobile device and cause the mobile device to perform functions, such as communicating with the mobile device processing system, displaying a device identifier (such as a bar code), placing the display in an on- or off-configuration, receiving inputs from an input component such as a stylus, and comparing inputs to expected inputs, among other functions.

According to another aspect of the present disclosure, a system for measuring the vibrations from a device is provided. The system comprises a panel with a cutout and a membrane stretched across the cutout. A sensor attached to a first face of the membrane and the second face is configured for receiving the device. The sensor may be connected to a computing device. The membrane isolates the sensor from ambient noise and system vibrations while achieving a higher signal-to-noise ratio compared to indirect microphone-based approaches that detect airborne acoustic signals.

In another aspect of the present disclosure, a flip and fold testing apparatus is provided for evaluating flip and foldable devices, featuring a universal jig adaptable to various device shapes, a mechanism that actively opens and closes device lids in a controlled manner, a force sensor that measures the force applied during these operations, and a microphone for detecting sounds from hinge mechanisms. Additional features include acoustic detection of lid operation defects, alignment of the device hinge with the rotation axis, testing of hinge position sensors to measure lid angle, and evaluation of display functionality in both open and closed positions.

In another aspect, an active stylus testing apparatus is disclosed for evaluating an active stylus used with a mobile device. The system includes a stylus jig to hold the device with the stylus inserted, a mechanism to extract and reinsert the stylus, and a holder to secure the stylus during testing. Features may include a hook-based extraction mechanism, a robot arm to position the device, and tests for pressure sensitivity, tilt detection, button functionality, and touchscreen performance. For devices supporting active styluses, touchscreen tests may be conducted using both capacitive and active styluses.

In another aspect, a load manager system oversees multiple inspection and testing cells, each with its own conveyor segment. The software directs devices entering the system to individual cells and manages conveyor operations for efficient movement from entry to exit. Additional features include tracking tests to prevent duplication, balancing usage across cells to minimize maintenance, routing devices to specialized cells as needed, feeding unused specialized cells, real-time monitoring of cell status, automatic performance optimization, and redundancy by switching tasks between cells if one fails.

According to another aspect of the present disclosure, a secure communication gateway for managing communications between a mobile device processing system and a backend platform is provided. The secure communication gateway comprises a gateway device disposed at a client site and configured to communicate with the backend platform. The gateway device is configured to orchestrate test sequences between the mobile device processing system and a mobile device test application without exposing test sequence details to the mobile device processing system. The gateway device is configured to manage secure access to the backend platform without exposing proprietary access information to the mobile device processing system.

This summary is intended to introduce a selection of concepts in a simplified form that is further described in the detailed description section of this disclosure. The summary is not intended to identify key or essential features of the claimed subject matter, nor is it intended to be an aid in determining the scope of the claimed subject matter. Additional objects, advantages, and novel features of the technology will be set forth in part in the description that follows, and in part will become apparent to those skilled in the art upon examination of the disclosure or learned through practice of the technology.

### BRIEF DESCRIPTION OF THE DRAWINGS

The present technology is described in detail below with reference to the attached drawing figures, wherein:

FIG. 1 is an example of a system setup utilizing multiple cells arranged serially together with multiple receiving stations.

FIG. 2 illustrates a block diagram of an automated mobile device processing system, according to aspects of the present disclosure

FIG. 3 illustrates an isometric view of a receiving station, in accordance with an aspect described herein;

FIG. 4 illustrates an isometric view of a preparation station, in accordance with an aspect described herein;

FIG. 5 illustrates an isometric view of an automatic preparation cell, in accordance with an aspect described herein; and

FIG. 6 illustrates a perspective view of an inspection and testing cell (with some panels removed to show parts of the interior), according to aspects of the present disclosure;

FIG. 7 illustrates another perspective view of the inspection and testing cell of FIG. 6, according to aspects of the present disclosure;

FIG. 8 illustrates a top-down plan view of the inspection and testing cell of FIG. 6 (with some panels removed to show parts of the interior), according to aspects of the present disclosure;

FIG. 9 illustrates a front view of the inspection and testing cell of FIG. 6 (with some panels removed to show parts of the interior), according to aspects of the present disclosure;

FIG. 10 illustrates a block diagram of an internal architecture of an inspection and testing cell, according to aspects of the present disclosure;

FIG. 11 illustrates a perspective view of a vibration testing apparatus, according to aspects of the present disclosure;

FIG. 12 illustrates a cross-sectional side view of the vibration testing apparatus of FIG. 12, according to aspects of the present disclosure;

FIG. 13 illustrates a flow diagram of a method for processing a mobile device, according to aspects of the present disclosure; and

FIG. 14 illustrates an example computing device suitable for implementing aspects of the technology, in accordance with an aspect described herein.

### DETAILED DESCRIPTION

The process of preparing used mobile devices for resale involves several technical challenges, particularly in the areas of inspecting, repairing, and grading. Traditionally, these processes were performed manually, which introduced a range of problems. These problems are often compounded when trying to automate any one of these processes.

Inspection of used mobile devices can be done to identify defects and assess a device’s condition. Manual inspection is time-consuming and prone to human error, as it relies on the skill and attention of the technician. Further, during the manual inspection process, often certain tests are subjective in nature. One such test is for a person to run their finger across a visible scratch to determine whether the scratch is superficial (and therefore can be buffed out) or the scratch is deeper into the surface (and therefore the scratched component needs replaced). The outcome of this test frequently varies from person to person.

Further, developing automated systems that can accurately detect cosmetic and functional defects is complex, as these systems may need to work across a wide range of issues, from minor scratches to significant hardware failures. Inspecting internal components, such as circuit boards and connectors, requires advanced imaging and diagnostic tools. Ensuring that these tools can detect subtle defects without disassembling the device is a significant challenge. In some cases, it’s not enough to simply diagnose or recognize an issue, but the automated system may need to further determine the magnitude of the issue, such that a decision may be made whether the repair or replace a component, or rather identify the damage for a downstream consumer.

Repairing used mobile devices can involve addressing both cosmetic and functional issues. Manual repairs can be inconsistent, as they depend on the technician’s expertise and familiarity with the particular part being repaired. Performing repairs, such as micro-soldering, screen replacement, and buffing requires precision to avoid causing additional damage. Automating the repair process is challenging because it involves developing systems that can perform operations with high precision and consistency. This problem is also compounded due to the high number of different device types, along with the constant introduction of new device and software systems.

Finally, grading devices for redistribution and reuse involves assessing their condition and accurately conveying the condition downstream. Manual grading often involves subjective assessments, which can lead to variability in the assigned grades. There is no universal standard for grading used mobile devices, leading to inconsistencies in grading criteria. Automating the grading process is challenging because it involves implementing objective, automated grading systems that can consistently evaluate devices based on predefined standards or criteria. Developing systems that can accurately assess both cosmetic and functional aspects of the devices without human intervention is a significant hurdle.

The present disclosure generally relates to an automated mobile device processing system that streamlines the inspection, repair, and grading of mobile devices. An example system comprises a single cell, within which is contained the necessary testing apparatuses for performing different tasks such as cosmetic inspection, display inspection, camera inspection, audio inspection, USB testing, and among others.

In aspects, two or more cells may be set up in a serial fashion to increase throughput without adding additional human operators. In an aspect, the cells are similarly configured so as to perform the same or substantially the same operations using one or more of the same systems.

In aspects, this may be achieved by one or more of the following features, including the utilization of integrated and distinct conveyor systems for each cell, and by the utilization of a “load manager” software control system to measure and adjust operations of the overall system, enabling ad-hoc scalability while most efficiently optimizing the line throughput and system utilization.

Using the cells in accordance with the present disclosure may also provide a redundancy of functions and capabilities that reduces downtime of the overall system in the event that one or more cells (or specific functionality within a cell) is compromised. For example, when a particular system of a first cell stops functioning, a corresponding system of a second cell, such as an adjacent cell, automatically begins performing the functions that were stopped within the first cell.

Automation equipment in the industry often works with a conveyance system (e.g., a conveyor belt) running physically separated from the system, e.g., a conveyor belt running alongside, but not through, a series of cells. In such a scenario, the conveyor system typically uses only one belt that is often moving continuously. While simple to set up such a system, extra equipment is often required for transferring the mobile devices off the belt and into the cells for testing. Furthermore, the continuous motion of the belt makes it difficult to address scenarios where the belt must continue to move.

In contrast, the present disclosure contemplates the use of multiple cells arranged in a serial fashion, with each cell having its own conveyor unit with its own belt, which can be controlled individually. In a system standalone scenario, the cell may be configured with a conveyor on board. Devices are being put in an ingress position for being analyzed, and taken off the conveyor egress position when the process is completed.

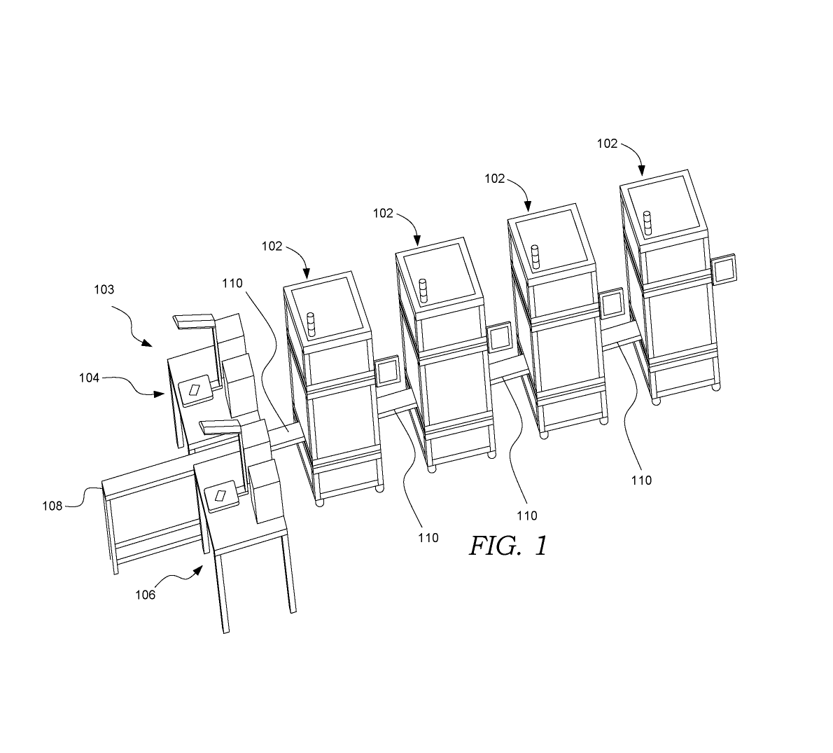

Referring to FIG. 1, a device processing system 100 (also referred to herein as system 100) comprises a plurality of inspection and testing cells 102 arranged in series. As further described below, each cell in the line may be configured with the same diagnostic or testing subsystems (also referred to herein as features), so that each cell has the same functionality as the other cells. In other examples, one or more cells may have additional or different features. At one end of the system 100, one or more stations are provided for device preparation and ingress into the series of cells 102. In aspects, the one or more stations may include a receiving station 104 and a preparation station 106, further described below. In other aspects, other configurations and combinations of stations may be used (e.g., two receiving stations, 104, one receiving station and two preparation stations 106, etc.) In the example show in FIG. 1, a feeder conveyor 108 is positioned between the receiving station 104 and the preparation station 106. Receiving station 104 may be disposed upstream of the plurality of inspection and testing cells 102 and is configured to receive and prepare mobile devices for entry into the processing line. A preparation station 106 may also be disposed upstream of the first inspection and testing cell 102 so that it can receive devices from the receiving station 104. In the example shown in FIG. 1, preparation station 106 is positioned adjacent to receiving station 104, but in other examples, the preparation station can be positioned between the receiving station 104 and the first inspection and testing cell 102. Preparation station 106 is configured to also prepare mobile devices prior to inspection and testing operations performed by inspection and testing cells 102.

Each inspection and testing cell 102 includes an integrated conveyor segment 110 that extends through the cell 102. In aspects, the conveyor segment 110 may comprise a single conveyor or multiple conveyors serially aligned. The individual conveyor segments 110 of adjacent inspection and testing cells 102 are aligned end-to-end to form a continuous conveyance path through system 100. This arrangement enables mobile devices to be transported from one inspection and testing cell 102 to the next without requiring additional conveyance equipment external to the cells. As further shown in FIG. 1, inspection and testing cells 102 may be mounted on wheels 114 to allow each inspection and testing cell 102 to be individually moved, rearranged, or replaced within the system 100. The wheeled configuration enables flexibility in the arrangement of the components of system 100 and facilitates maintenance operations. For example, an inspection and testing cell 102 may be rolled out of position for servicing while a replacement cell is rolled into position to maintain operation of the system 100. With individual conveyor segments 110, inspection and testing cells 102 may be hot-swapped for maintenance without retrofitting or replacing other components of the system 100, such as a separate conveyor belt. Because each inspection and testing cell 102 includes an integrated conveyor segment 110, no additional equipment may be needed to pick devices from an external conveyor when cells are moved within system 100. Inspection and testing cell 102 may be mounted on lockable wheels. The lockable wheels enable inspection and testing cell 102 to be moved, rearranged, or replaced within device processing 100. When the wheels are locked, inspection and testing cell 102 may be secured in position within device processing 100 during normal operation. The lockable wheel mounting facilitates hot-swapping of inspection and testing cells 102 for maintenance without retrofitting device processing 100.

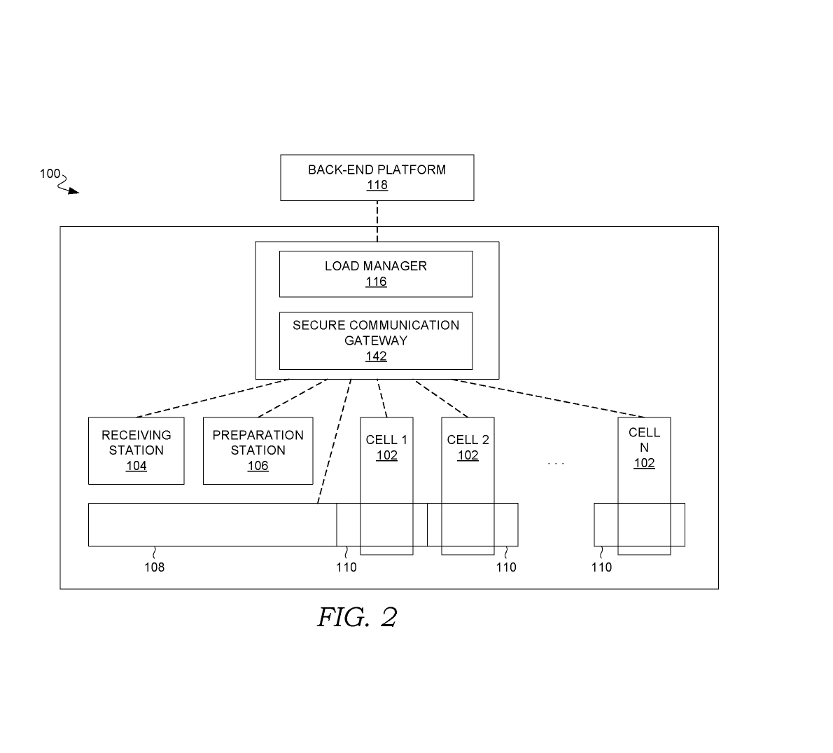

Referring to FIG. 2, a block diagram of the system 100 shown in FIG. 1 is depicted. As illustrated in the block diagram, system 100 includes a load manager 116 and a backend platform 118 operatively coupled to the various system components, such as the cells 102, receiving station 104, preparation station 106, and the feeder conveyor 108 and the conveyor segments 110. Load manager 116 is operatively coupled to the plurality of inspection and testing cells 102 to control device distribution and conveyor operations along the processing line. Backend platform 118 is operatively coupled to load manager 116 to receive, store, and analyze test data from system 100. The test data may include device pictures, audio recordings, and other inspection results generated by inspection and testing cells 102 during processing operations. As further discussed below, the load manager 116 may be used to balance system utilization to maximize overall throughput through the line of inspection and testing cells 102 while distributing usage across the cells to minimize wear and subsequent maintenance efforts. By distributing device processing operations across inspection and testing cells 102 in a balanced manner, load manager 116 may extend the operational lifespan of individual cells and reduce the frequency of maintenance interventions.

In examples, the load manager 116 may be a part of or operatively connected to a secure communication gateway 142 that manages secure access to backend platform 118 without exposing proprietary access information to test system software or infrastructure system software. The secure communication gateway 142 may provide a secure intermediary layer between the inspection and testing equipment within the processing cells 102 and backend platform 118 that stores device data, test configurations, and processing results. By channeling communications through the secure communication gateway 142, the automated mobile device processing system may prevent test systems from directly accessing backend platform 118 and may prevent exposure of proprietary access credentials, authentication tokens, or platform interface details to the test system software.

The secure communication gateway 142 may orchestrate test sequences between test systems and a mobile device test application without exposing test sequence details to the test systems. The secure communication gateway 142 may transmit instructions to the test systems and to the mobile device test application (e.g., via the load manager 116) to synchronize operations without revealing the complete test sequence logic to either the test systems or the mobile device test application. By maintaining the test sequence details within the secure communication gateway 142 rather than distributing the test sequence details to the test systems, the automated mobile device processing system may protect proprietary testing methodologies and may enable modification of test sequences without requiring updates to test system software.

The secure communication gateway 142 may be installed at a customer site as a compact computing device running an open-source operating system. The secure communication gateway 142 installed at the customer site may channel all communication to backend platform 118, serving as a single point of communication between the customer site equipment and backend platform 118. The secure communication gateway 142 may have an Ethernet connection to the test systems within the automated mobile device processing system for transmitting test instructions, receiving test results, and coordinating operations. The secure communication gateway 142 may have a WiFi connection to the mobile device test application executing on mobile devices being tested, enabling communication with mobile devices as the mobile devices move through the processing line on conveyor segments and as the mobile devices are manipulated by robot arms within the inspection and testing cells.

The components of the system 100, such as the conveyor segments 110 and the testing equipment within the cells 102 may receive instructions from the secure communication gateway 142 specifying actions to be performed and positions at which the actions are to be performed without receiving information about the identity, type, or characteristics of the mobile device being tested. The test systems may execute the commanded actions at the specified positions while the secure communication gateway 142 and load manager 116 orchestrate the overall test sequence and coordinates the actions of the test systems with the operations of the mobile device test application. The secure communication gateway 142 may expose a safe API (application programming interface) that allows OEMs (original equipment manufacturers) to control complete test sequences without knowing all the details of the test system. The safe API may abstract the underlying test system implementation details, enabling OEMs to interact with the automated mobile device processing system through a standardized interface without requiring knowledge of the specific test equipment, test procedures, or system architecture employed by the test systems. The secure communication gateway 142 may also enable OEM diagnostic tool integration by exposing an API that an OEM can support to control the test system, enabling the OEM diagnostic tool to issue commands to the automated mobile device processing system and retrieve test results without requiring the OEM to understand or access the internal details of the test systems.

Test results may be provided by backend platform 118 through the secure communication gateway 142 to the customer. The test results generated by the inspection and testing operations may be transmitted from the test systems to the secure communication gateway 142, and the secure communication gateway 142 may forward the test results to backend platform 118 for storage and analysis. Backend platform 118 may process the test results and generate output data for delivery to the customer through the secure communication gateway 142. The output data may include device grades, defect reports, inspection images, and other information derived from the inspection and testing operations.

The test results provided through the secure communication gateway 142 may be delivered to the customer by printing a label to be applied to the device. The label may include information such as the device grade, device identifier, test date, and summary of inspection results. The label may be printed by a label printer at the egress position of the device processing line or at another location within the customer facility. The printed label may be applied to the mobile device by an operator or by an automated labeling system, providing a physical record of the test results that accompanies the mobile device through subsequent handling and distribution processes. The test results may also be delivered to the customer by showing the test result on a UI (user interface) monitor. The UI monitor may be a display monitor positioned at an operator workstation or at another location within the customer facility where operators or quality control personnel can view test results. The test results displayed on the UI monitor may include detailed inspection data, images of identified defects, test pass/fail status, and device grades. The UI display of test results may enable operators to review inspection outcomes, make decisions about device disposition, and identify devices that require additional attention or manual inspection.

The processing system for automated processing of mobile devices may be customizable to individual customer requirements. The customization may include which measurements to perform during inspection and testing operations. Different customers may have different requirements for the types of inspections and tests to be performed on mobile devices based on the intended use of the devices, the target market for resale, or the quality standards applied by the customer. The processing system may enable customers to select which inspection and testing operations are performed on mobile devices traversing the processing line, enabling customers to tailor the processing workflow to specific business requirements.

The customization may include specific measurement thresholds applied during inspection and testing operations. Measurement thresholds may define acceptable ranges or limits for various parameters measured during inspection and testing, such as display brightness levels, audio output levels, battery capacity percentages, or defect size limits. Different customers may have different tolerance levels for various types of defects or performance characteristics based on the grading standards applied by the customer or the expectations of downstream purchasers. The processing system may enable customers to configure specific measurement thresholds that determine whether a mobile device passes or fails particular tests and how the mobile device is graded based on the measurement results.

Turning back to FIG. 2, the load manager 116 may instruct the conveyor segments 110 to deliver certain mobile devices to particular cells for specialized testing. For example, one inspection and testing cell 102 may be equipped with a specialized testing apparatus, such as a flip testing jig for testing flip phones and foldable devices. Load manager 116 may direct the components of the system 100 so that all applicable devices, such as flip phones and foldable devices, are processed through the dedicated inspection and testing cell 102 equipped with the flip testing jig. Load manager 116 may route devices that do not require flip testing to inspection and testing cells 102 that do not have the flip testing jig. If the inspection and testing cell 102 equipped with the flip testing jig is not being utilized for flip phones or foldable devices to full capacity, load manager 116 may feed additional devices to the underutilized inspection and testing cell 102 to maximize throughput through system 100.

As further described below, each cell in the line may be configured with the same diagnostic or testing subsystems (also referred to herein as features), so that each cell has the same functionality as the other cells. In other examples, one or more cells may have additional or different features. While four cells are shown in the example of FIG. 1, the use of more or fewer cells is also contemplated.

In a line configuration, the conveyor segments 110 are set up end-to-end, in a way that devices processed through the line are handed over from conveyor segment 110 to conveyor segment 110. As further described below, once on a conveyor segment 110, the devices may be moved into a cell and brought into a “pick position” for a robot arm within the cell, with no additional accessories required. When a device is being picked up by the robot arm, the particular conveyor segment may be stopped intermittently (e.g., ~2s), the device’s exact position is measured, and the arm takes the device with high precision for carrying out testing and analytics. While the system runs this process with the picked device, the integrated conveyor segment 110 may continue to move, which allows it to carry other devices, which either have already been tested by other cells 102 upstream in the line, or which are to be tested by other cells 102 downstream. This enables a continuous flow of devices through the line. A conveyor segment of one cell 102 can be stopped individually for device picking, without stopping the conveyor segments 110 of the other cells 102 of the line, which supports high precision gripping and positioning while still allowing the conveyor segments 110 to continuously convey devices from ingress to egress. For example, a first cell and a second cell are adjacent cells, each having an independently functioning conveyor that together are positionally configured to transfer a mobile device between the conveyors. In this example, while the conveyor segment 110 of the first cell 102 is stopped, the conveyor segment 110 of the second cell 102 may be operational.

Without line integration, operating multiple standalone cells in parallel, would provide the same throughput per system compared with a line-up configuration. But here, as the ingress and egress positions would multiply, manual efforts would increase. In an integrated line-setup, only one ingress and one egress position may be staffed, maximizing operator utilization.

With integrated conveyor segments, cells can be hot-swapped for maintenance without retrofitting the line. As each cell can be configured to perform any of the specific operations, one can take the place of any other at any point in time and the replacing cell can be configured to perform the operations of the cell being removed by operationally activating one or more of a plurality of available features within the cell, e.g., a first feature may be operationally activated to perform functions on a mobile device while a second feature may be or remain deactivated. While in some cases the overall line capacity might be diminished, remaining cells continue to perform, effectively avoiding a complete downtime. In order for the line to continue working, a cell that is removed from the line (e.g., on wheels) is either replaced with a spare cell, or its place in the line is filled with the next subsequent one. As described above, no additional equipment may be needed to pick devices from an external conveyor, so additional setting up and calibrating such equipment is not required if cells are moved within the line. Cells can thus be taken out of the line or change position within the line on demand, with minimal efforts, and ensuring line contingency.

In standalone operation, a conveyor segment 110 may be controlled by the cell or system in which it is implemented. In any multi-system “line up” configuration having a plurality of cells configured to move a mobile device between cells, each conveyor segment of each cell may be independently controlled by a dedicated “load manager” software instance, further described below. This software monitors all devices entering the line (coming from receiving stations, at which devices are prepared for being analyzed), and distributes them to the individual cells along the line. This way, the load manager ensures that every device is being tested and analyzed, but is not double tested. For example, the load manager may identify that a first cell and a second cell that are in line are both performing a same operation using a same system, i.e., a device passing along this line would be tested in the same manner separately by each of the two cells. Based on identifying this duplicative functionality, the load manager may modify the functionality of one of the cells to stop the cell responsible for the function from performing the operation on the device. It may also control the stop-and-go of the individual conveyor belts in a way to most efficiently process devices from the line ingress to the egress point. Furthermore, the load manager may balance the system utilization to maximize overall throughput through the line of cells. In an aspect, the load manager may balance the utilization of the cells to ensure equal wear out for minimized maintenance efforts. In case one or more cells with different configurations supporting special use cases are integrated to the line, the load manager can consider accordingly and ensure devices are routed correctly. For example, if one cell only is equipped with a flip testing jig, the load manager can process all applicable devices (e.g., flip phones, foldable devices) through this dedicated cell, while routing devices that do not require flip testing through the cells that don’t have a flip testing jig. Moreover, if the specifically equipped cell is not being utilized for flip / foldables to its fully capacity, it may be fed with additional devices. The load manager actively monitors the cells in the line for their configuration and operation status, and distributes devices most efficiently. A multi-cell system may thus be automatically managed in “real time” to optimize performance and work around potential technical issues.

The present disclosure solves many of these problems, presenting an automated, streamlined approach for inspecting, repairing, and grading, among other features and functions. In an aspect, a single processing cell is designed to perform multiple specific tasks, such as physical inspection and functional inspection. In an example, the system can operate with a throughput of 30-50 units per hour. To achieve the required throughput, the design involves parallelization within each cell. For example, the cell may be configured to handle multiple devices simultaneously.

In aspects, two or more cells may be aligned serially to improve throughput and to provide redundancy to mitigate loss of due to one or more components of a particular cell being inoperable. Each cell may have its own conveyor system and may be controlled by a central control, thus enabling greater flexibility in the routing and throughput of devices through the system.

In general, various example aspects of an automated mobile device processing system are provided. In some aspects, the automated mobile device processing system may be designed to automatically perform inspection, repair, and grading, or another like process, on a mobile devices in a streamlined and efficient manner. A mobile device processing system may comprise a plurality of cells, as will be further described.

A mobile device may be a type of computing device that is designed to be portable by an individual. Examples of mobile devices include smartphones, tablets, smartwatches, personal digital assistants (PDAs), MP3 players, satellite location (e.g., GPS) devices, handheld communication devices, gaming devices, handheld entertainment systems, remote controls, and other portable consumer electronic devices. Typically, mobile devices are configured to have wireless network access, such as through Wi-Fi, Bluetooth, cellular networks, or the like.

In an aspect, the mobile device processing system may operate to processes a particular number of mobile devices within a given time frame. In an example, the system may operate with a 90-second takt time, meaning that a mobile device can enter and exit a cell every 90 seconds. Stated differently, the mobile device processing system may have a throughput of about 40 devices an hour. In aspects, this is achieved through a processing system and parallelization within cells based on a length of time for the cell to perform a corresponding process.

In an aspect, the automated mobile device processing system comprises a transfer system having one or more components that assists in moving mobile device through the system and between cells. For example, the transfer system may include components such as a notification mechanism, a timing (speed) mechanism, a unit identification mechanism, or the like. In an aspect, the notification mechanism aids in synchronizing device flow between cells by notifying the next cell when a unit exits the previous cell. In an aspect, the timing mechanism tracks the speed or timing of the devices moving between cells, and may estimate when a device will leave one cell and arrive at the next. In an aspect, the unit identification mechanism uses bar codes, such as a QR code, on each device to confirm that the expected unit leaves one cell and arrives at the next. In an aspect, the bar code is displayed by the device and read from the mobile device display. The transfer system may include a conveyor system comprising a plurality of conveyors, where each conveyor corresponds to an individual cell within the system. Each conveyor may be independently operably, including operable at the cell level or by a load manger providing instructions for multiple cells within the system.

In one example, a mobile device may move to a cosmetic inspection feature, a touch screen inspection feature, and an acoustic inspection feature within a cell for inspecting the physical features of the mobile device. The mobile device may be further moved within the cell to a camera inspection feature and a wired communication feature to test various components, such as the camera and battery, among other components. In aspects, other cells or combinations of systems may be employed within a cell. In an aspect, each system is independently operable. As such, a cell may be configured to employ a first system while not employing another system with which it is configured to employ. n examples, the device may be processed in one or more additional systems or cells where other functions may be performed; for example, the device may be moved to a separate device buffing system to remove scratches and other defects.

In an aspect, based on the inspection and buffing, for example, a device may be assigned a grade. Any grading scale may be used. The mobile device processing system inspects a mobile device and may assign it a grade using a consistent grading scale.

For instance, a device grade may be assigned by assessing physical defects, age, battery operability, and other functional or physical aspects, for instance. For example, the presence and location of scratches may affect the grade. For example, a device with a scratch pattern at the edges might receive a higher grade compared to one with a scratch pattern more centrally located on the display. In some cases, older devices may be graded relatively lower due to potential wear and tear, outdated hardware, and reduced performance capabilities. In an aspect, the health or performance of the battery can be used as a grading factor. Mobile devices with batteries that hold a relatively longer charge and have a relatively higher capacity might receive a higher grade compared to those with degraded batteries. The grade may be based on other functional performance factors, such as the responsiveness of the touchscreen, the functionality of its buttons, the performance of the operating system, and the like. Other factors, such as the condition of the camera, speakers, and ports, as well as any signs of water damage or previous repairs, may also be used when determining the grade. These are just a few examples of factors that may be assessed by the mobile device processing system and used to consistently assign grades to mobile devices.

To provide one example scale, a Grade A device might be in excellent condition with minimal signs of use, no significant scratches or dents, a battery that operates at near full capacity, or all functions working perfectly. A Grade B device might show moderate signs of use, such as minor scratches around the edges, a good battery charge, or no major functional issues. A Grade C device might have noticeable scratches, including some more relatively central on the display, a battery that does not hold a charge as originally designed, or minor functional issues, but still be operational. A Grade D device might have significant physical damage, such as deep scratches or dents, poor battery performance, or functional issues that affect usability.

In an aspect, the grading scale is determined using generative artificial intelligence (AI). Generative large language models (LLMs) may be used to determine the grading scale, for example. For instance, a generative model may be prompted (including one or more inputs) with a condition of a device. For example, the prompt may comprise a condition like moderate signs of use, such as minor scratches around the edges, a good battery charge, or no major functional issues. The model may be further prompted to return a grade based on consumer expectations for this condition of phone. As such, a grading scale may be determined by inputting a combination of conditions for device, and prompting the model to return a grade based on consumer expectations. Later, devices within the processing system may be compared to these grading scales to assign a grade.

In another aspect, the condition of a device is assessed as the device traverses the processing system. Each cell along the processing system may be configured to information about the device using one or more inspection systems, such as the cosmetic inspection feature, acoustic inspection system, or another such inspection systems. The model may be prompted with a grading scale and a request to assign a grade using the scale to the mobile device based on the condition.

### Example systems and components

Example systems or components are now described with reference to the figures.

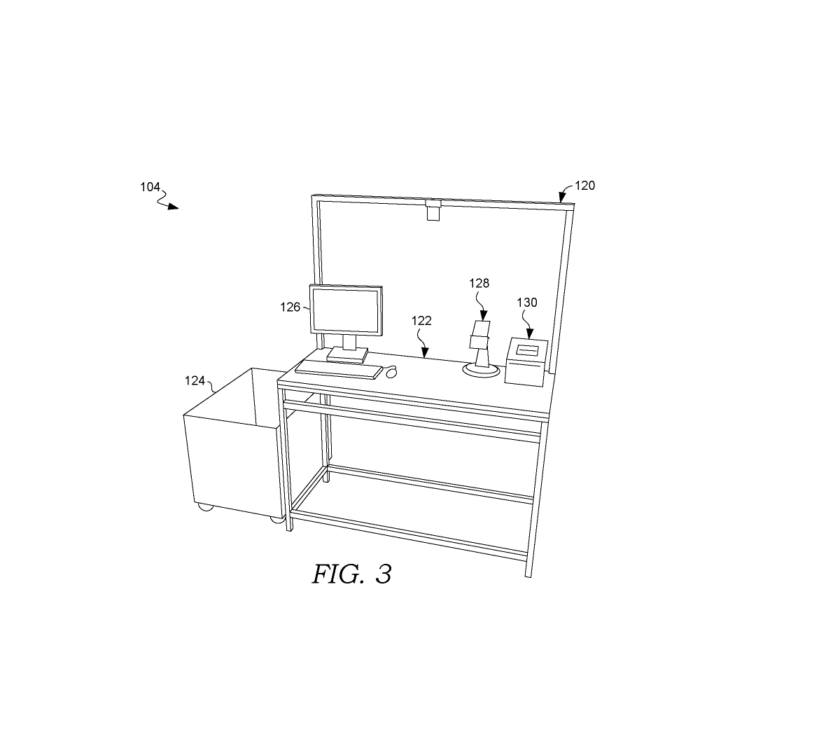

FIG. 3 is an example receiving station 104. As illustrated in FIG. 3, the processing line for automated processing of mobile devices may include a manually operated work station designed for device receiving. In examples, receiving station 104 includes a workstation frame 120 having a rectangular base platform supported by legs and a vertical support structure extending upward from a rear portion thereof. A work surface 122 is disposed horizontally across workstation frame 120, preferably at an ergonomic standing height, providing a workspace for operator interaction with mobile devices entering the system 100. Proximate to the work surface 122 is a receptacle or storage bin 124 for receiving and holding a plurality of mobile devices for storing accessories or other items separated from mobile devices during receiving operations. In the example shown in FIG. 3, the receptacle or storage bin 124 is a positioned adjacent to the work surface 122 but other configurations are possible. A display monitor 126 is mounted on a stand atop work surface 122 toward a left side of receiving station 104. Display monitor 126 may be accompanied by a keyboard for operator input. Display monitor 126 may display system information and operator guidance during device receiving operations. A barcode scanner 128 is disposed on work surface 122 toward a right-center region of receiving station 104. Barcode scanner 128 may be mounted on a pedestal stand and configured for scanning shipment and device barcodes for data validation and cross-checking against backend platform 118. A label printer 130 is disposed on work surface 122 toward a right side of receiving station 104. Label printer 130 is configured for printing device identification labels on demand for manual application to mobile devices received at receiving station 104. The receiving station may also include various components for operatively connecting to the mobile devices to be tested, such as USB cables and charging cables.

The receiving station 104 is thus configured to induce system and device data into the relevant IT (information technology) systems. For instance, receiving station 104 may be used to separate devices from accessories and channel them into technical processes supported by the system. The functionality of receiving station 104 may include scanning shipment and device barcodes for data validation and cross-checking against backend systems. Additionally, device ID labels can be printed at receiving station 104 on demand for manual application. Further, device batteries may be charged at the receiving station 104 in a managed way (e.g., monitoring charge levels during charging and terminating the charging process once a minimum charge level is reached). Additional functions that may be performed at the receiving station 104 may include data wipes of unwanted data from device memory, upgrading device firmware as needed and installing testing apps on devices.

The process flow at the receiving station 104 may be managed through software with operator guidance, including customer-specific operator prompts for manual tasks to be performed and confirmed. For example, these tasks may include scanning the ID (identification) barcode, checking the physical completeness of the device, removing accessories and labels, checking for visible signs of water damage, and applying the ID label to the device. An optional overhead camera for operator observation may be available, with capabilities for capturing or streaming pictures or video to be supported by the system.

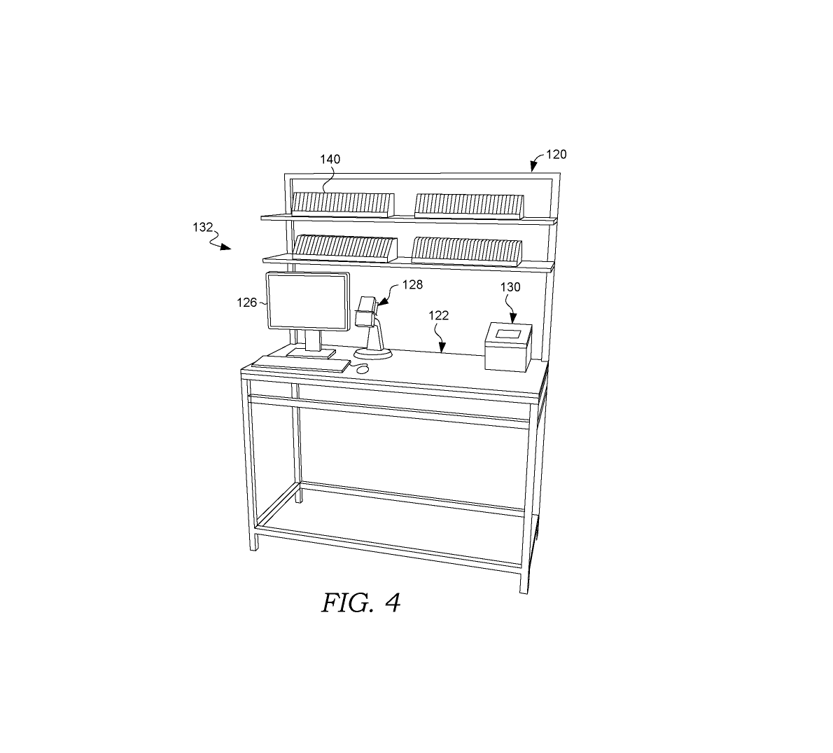

FIG. 4 is an example preparation station 106. In the example shown, preparation station 106 includes many elements similar to the receiving station 104, including a workstation frame 120, work surface 122, display monitor 126, barcode scanner 128 and label printer 130. The preparation station 106 may also include a storage space 132 for organizing and storing mobile devices during preparation operations prior to entry into inspection and testing cells 102. In the example shown in FIG. 4, the storage space includes two horizontal shelf levels, each with a plurality of device slots 140 arranged in rows to hold individual mobile devices in a readily accessible location, but other configurations are contemplated to be within the scope of the present disclosure. The preparation station 106 may also include various components for operatively connecting to the mobile devices to be tested, such as USB cables and charging cables.

In examples, the preparation station 106 is a semi-automated workstation configured to receive mobile devices having an unknown status and prepare them for inspection and testing via subsequent cells. While the technical process is highly automated by the software running on the station to instruct an operator, the preparation station 106 may support the operator to connect devices to USB ports, apply the ID label, etc.

The functionality of the preparation station 106 may include managing the process flow through software with operator guidance, including customer-specific operator prompts for manual tasks to be performed and confirmed. The preparation station 106 may comprise a computer interface for receiving operator inputs. In aspects, it can identify devices by IMEI or MSN through USB or lightning connection, wipe device data, monitor device battery charging, update device software or flash to a defined firmware version, unlock devices, check carrier lock, check device stolen status, and install and launch a mobile device test app. In aspects, it can print device labels for manual application and provide a pressured air supply for manual device or device port cleaning supported by an operator. The sequence of such functions can be tailored to the individual needs of the customer and use case.

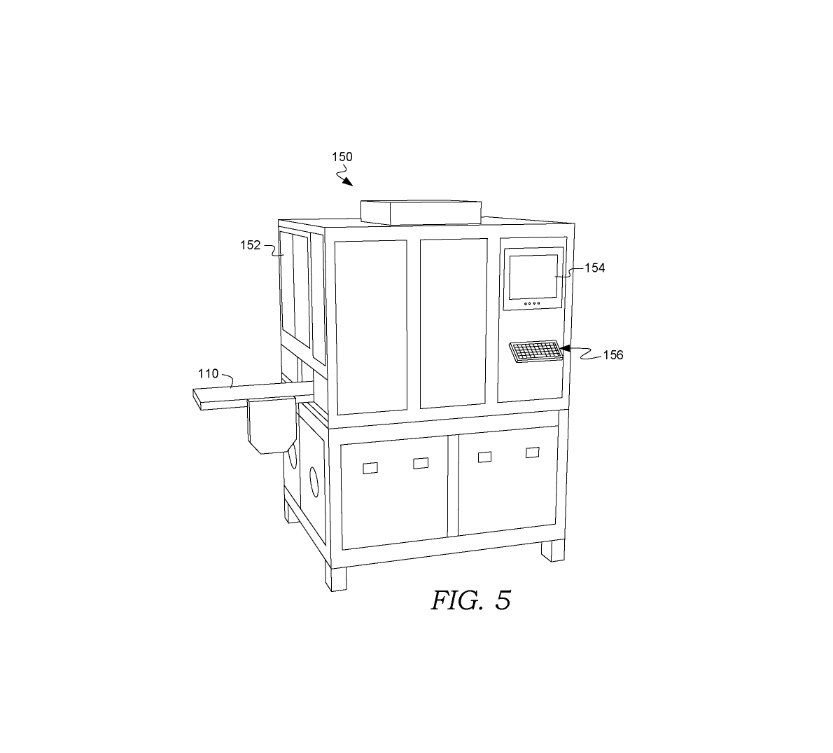

FIG. 5 is an example automatic preparation cell (also referred to herein as an auto prep cell) 150. which is configured to provide the functionality similar to the preparation station 106 of FIG. 4 but in an automated manner. The auto prep cell 150 may receive mobile devices in any unknown status and prepare the mobile devices for inspection and testing via subsequent cells. In an aspect, a manual operator may be used for removing devices from the auto prep cell when the devices are identified as exceptions for manual handling. Auto prep cell 150 includes a housing 152, a conveyor segment 110, a monitor 154 and an input device 156, such as a keyboard. The conveyor segment extends out of opposite sides of the housing 152. The auto prep cell 150 contains equipment for automatically performing some or all of the functions described above with respect to the receiving station 104 and preparation station 106.

The functionality of the auto prep cell 150 may include automatic device power-up for different device types, such as iOS and Android devices, connecting devices to USB, lightning, or micro-USB connections, and identifying devices by IMEI or MSN through these connections. It may also wipe device data, monitor device battery charging, update device software or flash to a defined firmware version, unlock devices, check carrier lock, check device stolen status, and optionally install and launch a mobile device test app. In aspects, it can support device power-off and print device labels on demand for manual application. A pressured air supply for manual device or device port cleaning is also included. Such functionality may be configurable per device and tailored to the individual use case.

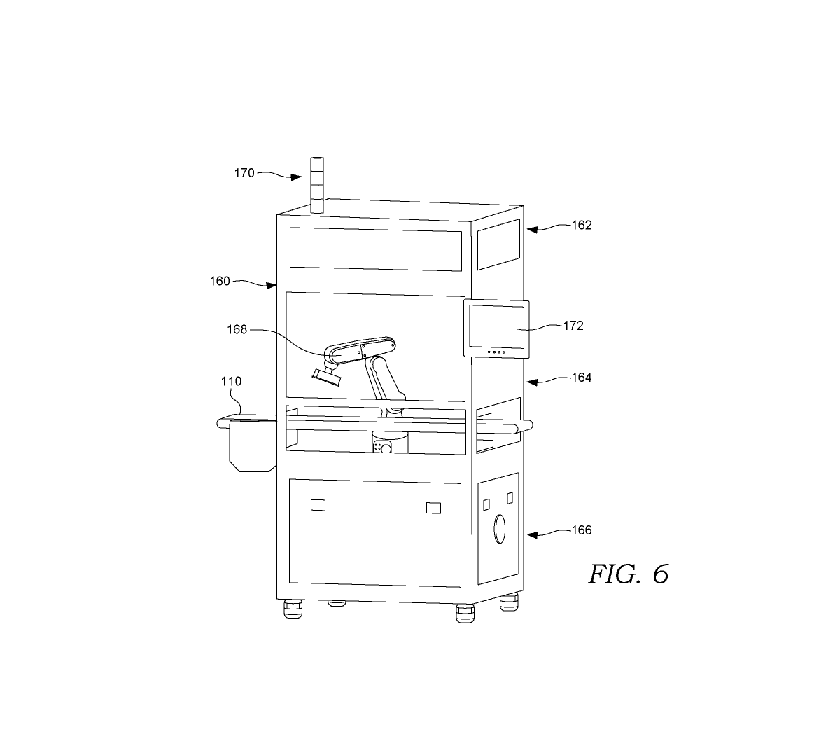

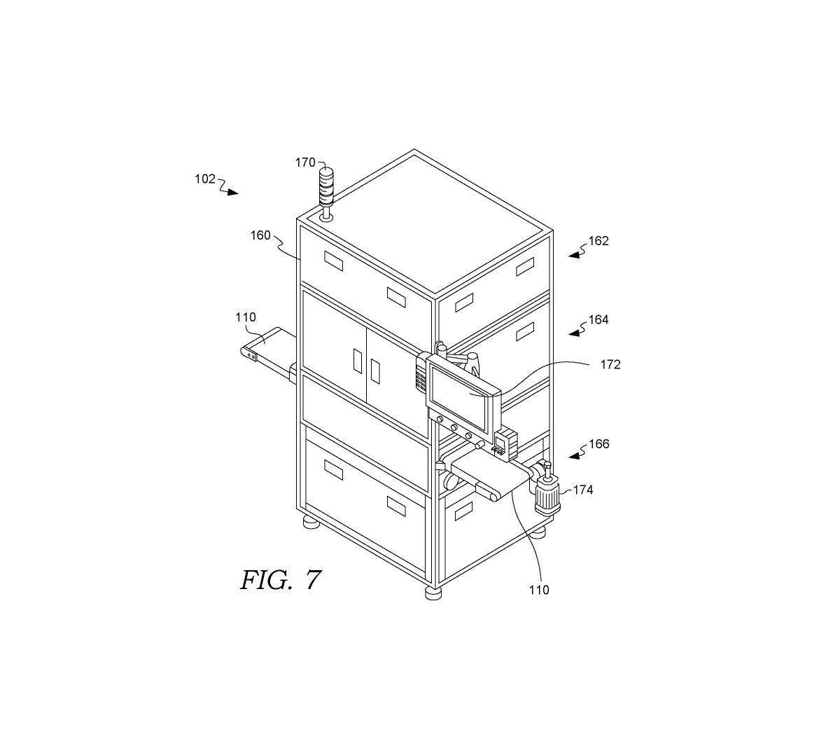

The inspection and testing cells 102 of the system 100 will now be described with reference to FIGS. 6-9. Turning first to FIG. 6, each inspection and testing cell 102 of the system 100 includes a housing 160 having a cabinet structure. Housing 160 is divided into three sections: a top section 162, a center section 164, and a bottom section 166. Top section 162 is disposed at an upper portion of housing 160 and may house a main junction box, a beam splitter unit, and GPIO (general purpose input/output) equipment. Center section 164 is disposed below top section 162 and contains test equipment and moving parts that carry out test operations on mobile devices. A bottom section 166 is disposed at a lower portion of housing 160 and may contain a system controller, a robot controller, a pneumatics panel, and a secondary junction box. With continued reference to FIG. 7, housing 160 encapsulates system moving parts within center section 164, with the exception of conveyor segment 110 which extends outwardly from housing 160. Center section 164 may include side panels that lock a system interior of housing 160. Safety measures may be provided that stop all operation and movements within inspection and testing cell 102 when the side panels are opened. The safety interlock panels provide protection for operators during maintenance or servicing operations while preventing unintended access to moving parts within center section 164 during normal operation.

Housing 160 may have a machine cabin floor footprint of approximately 1000 mm in width by approximately 860 mm in depth by approximately 1960 mm in height, excluding the removable indicator tower of status indicator 170. The left-right width of inspection and testing cell 102 may be approximately 1800 mm when including conveyor segment 110 integrated within inspection and testing cell 102. The system weight of inspection and testing cell 102 may be approximately 300 kg.

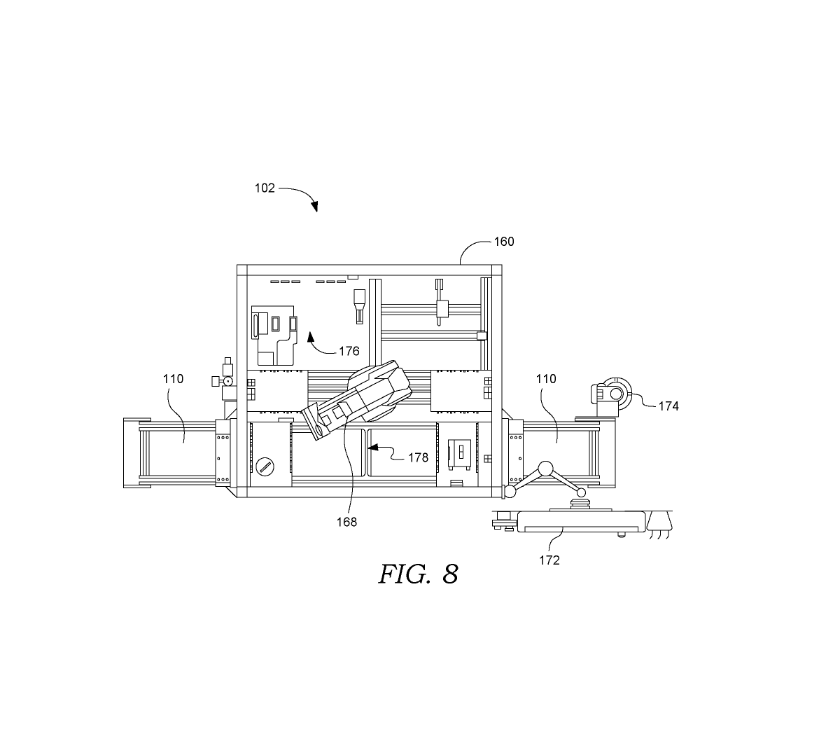

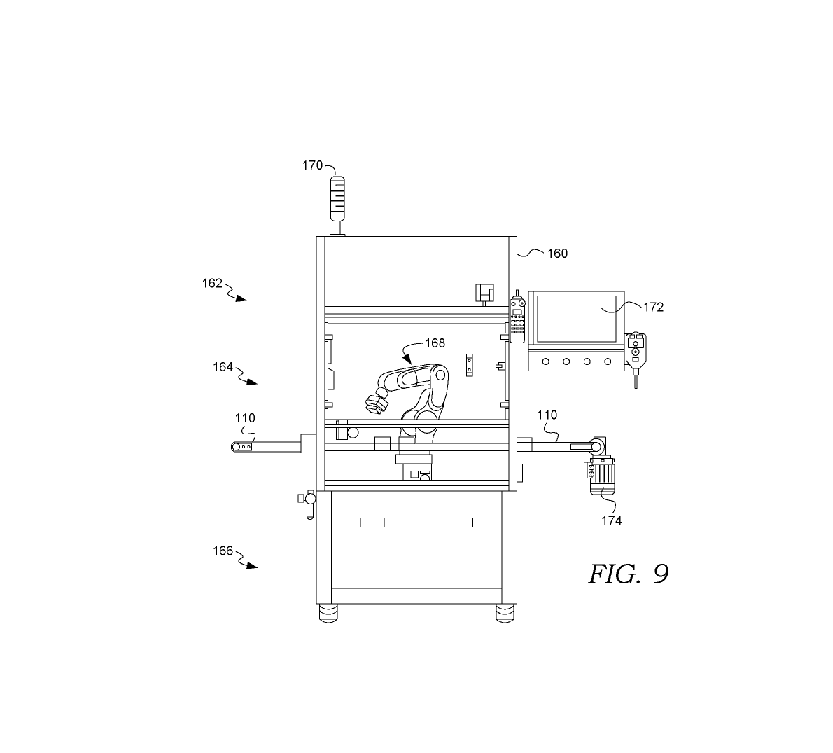

With continued reference to FIG. 6 and with reference to FIGS. 8 and 9, a robot arm 168 is disposed within center section 164 of housing 160. Robot arm 168 is configured for picking up and maneuvering mobile devices during testing operations performed within inspection and testing cell 102. Robot arm 168 may be a 6-axis robot arm mounted to a center position of center section 164, with test equipment arranged around robot arm 168. The centered mounting position of robot arm 168 enables robot arm 168 to reach test equipment disposed at various positions within center section 164.

With continued reference to FIG. 6, conveyor segment 110 extends from both sides of inspection and testing cell 102. Conveyor segment 110 provides an integrated conveyance path for transporting mobile devices into and out of inspection and testing cell 102. The integration of conveyor segment 110 within inspection and testing cell 102 enables mobile devices to be transported between adjacent inspection and testing cells 102 without requiring additional conveyance equipment external to the cells.

Referring to FIG. 7, another perspective view of inspection and testing cell 102 illustrates the three-section division of housing 160. Top section 112 is disposed at an upper portion of housing 160 and includes status indicator 170 mounted on an upper surface thereof. Center section 164 is disposed below top section 12 and includes display monitor 172 mounted on a front-facing exterior surface. Bottom section 166 is disposed at a lower portion of housing 160 and includes visible mechanical and pneumatic components accessible from an exterior of housing 160. A conveyor drive motor 174 is visible at a lower portion of inspection and testing cell 102. Conveyor drive motor 174 provides motive force for conveyor segment 110, enabling conveyor segment 110 to transport mobile devices into and out of inspection and testing cell 102. Conveyor drive motor 174 may be independently controllable, enabling conveyor segment 110 of each inspection and testing cell 102 to be operated independently of conveyor segments 110 of adjacent inspection and testing cells 102.

Turning back to FIG. 6, each inspection and testing cell 102 includes a status indicator 170 disposed on an upper surface thereof. Status indicator 170 may include signal lights or other visual indicators for displaying system status information, such as whether the cell is operational, processing a device, or requires attention. Status indicator 170 may provide operators with a visual indication of the operational state of each inspection and testing cell 102 along system 100. As further shown in FIG. 6, status indicator 170 is mounted on top of housing 160. Status indicator 170 may include signal lights for displaying system status of inspection and testing cell 102. Status indicator 170 may be configured as a removable indicator tower that extends upward from an upper surface of housing 160. Display monitor 172 is mounted on an exterior side of housing 160 adjacent to center section 164. Display monitor 172 provides an operator interface for monitoring system status and device status during operations of inspection and testing cell 102.

Referring to FIG. 8, a top-down plan view of inspection and testing cell 102 illustrates the internal layout with an upper wall of housing 160 removed. Housing 160 defines a rectangular enclosure within which various components are arranged for performing inspection and testing operations on mobile devices. A test equipment area 176 is disposed at an upper-left region within housing 160. Test equipment area 176 may include various testing apparatuses for performing cosmetic inspection, display inspection, camera inspection, audio inspection, wired communication testing, and vibration testing operations on mobile devices. In other examples multiple test equipment areas 176 may be present in the same cell 102.

With continued reference to FIG. 8, a device pick position 178 is located at a central region within housing 160. Device pick position 178 is the location where a mobile device is positioned on conveyor segment 110 for pickup by robot arm 168. Robot arm 168 is disposed below device pick position 178 and includes a multi-jointed articulated structure. Robot arm 168 is configured to pick up mobile devices from device pick position 178 and maneuver the mobile devices to test equipment area 176 for inspection and testing operations. After inspection and testing operations are complete, robot arm 168 may place the mobile device back onto conveyor segment 110 at an egress position for transport out of inspection and testing cell 102.

As seen in FIGS. 6-9, conveyor segment 110 extends horizontally from opposite sides of inspection and testing cell 102 at approximately the boundary between center section 164 and bottom section 166. Conveyor segment 110 provides an integrated conveyance path for transporting mobile devices into inspection and testing cell 102 to device pick position 178 and out of inspection and testing cell 102 after inspection and testing operations are complete. Conveyor drive motor 174 is disposed adjacent to conveyor segment 110 on an exterior side of housing 160, providing motive force for transporting mobile devices along conveyor segment 110.

Inspection and testing cell 102 may be configured to handle multiple mobile devices simultaneously. Robot arm 168 may place mobile devices into different positions within center section 164 for time-consuming tests and pick up the mobile devices again after completion of the tests. By positioning multiple mobile devices at different test equipment area 176 locations simultaneously, inspection and testing cell 102 may perform inspection and testing operations on multiple mobile devices in parallel, increasing the throughput of inspection and testing cell 102.

Inspection and testing cell 102 may operate with a defined takt time (e.g., 90 seconds). The defined takt time means that a mobile device may enter and exit inspection and testing cell 102 at a regular interval. The defined takt time provides a throughput of a plurality of devices per hour (e.g., approximately 40 devices per hour) through inspection and testing cell 102. The simultaneous handling of multiple mobile devices by robot arm 168 enables inspection and testing cell 102 to achieve the defined takt time despite individual inspection and testing operations requiring longer durations to complete.

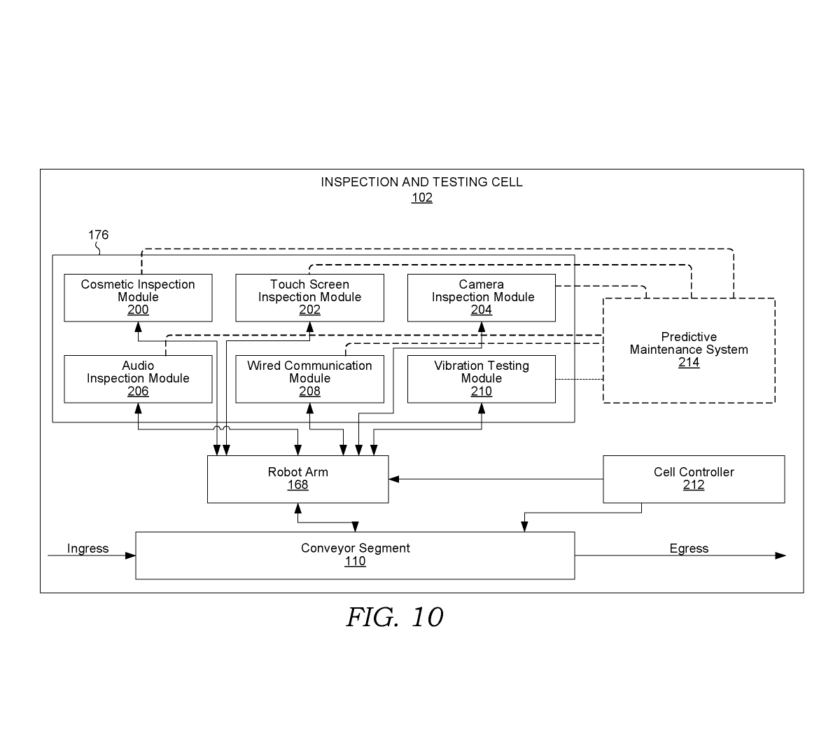

Referring to FIG. 10, a block diagram illustrating the functional architecture of inspection and testing cell 102 is provided. Inspection and testing cell 102 includes a plurality of testing modules with equipment positioned in one or more of the test equipment areas 176, a robot arm 168 disposed in a central portion thereof, and conveyor segment 110 disposed in a lower portion thereof. The plurality of testing modules that a cell 102 may have may include a cosmetic inspection module 200, a touch screen inspection module 202, a camera inspection module 204, an audio inspection module 206, a wired communication module 208, and a vibration testing module 210. In other examples, additional modules testing other features may be included or may replace one of the modules described herein. It is to be understood that the modules described herein are not necessarily discrete physical modules or packages; instead, a module is a grouping of a set of tests, such as a set of tests to detect physical defects, or a set of tests to inspect the display and touch functionality of a mobile device.

Robot arm 168 is configured to pick up a mobile device from conveyor segment 110 at an ingress position, maneuver the mobile device to one or more of test equipment areas 176 for inspection and testing by the various modules, and place the mobile device back onto conveyor segment 110 at an egress position.

A cell controller 212 is disposed at a right portion of inspection and testing cell 102. Cell controller 212 is communicatively coupled to robot arm 168 and conveyor segment 110. Cell controller 212 is configured to coordinate the operations of robot arm 168 and the transport of mobile devices along conveyor segment 110. Cell controller 212 may control the stop-and-go operation of conveyor segment 110 to position mobile devices at device pick position 178 for pickup by robot arm 168 and to transport mobile devices out of inspection and testing cell 102 after inspection and testing operations are complete.

With continued reference to FIG. 10, a predictive maintenance system 214 is communicatively coupled to each of the plurality of testing modules. Predictive maintenance system 214 is configured to monitor the status and performance of each testing module and generate alerts for maintenance requirements. Predictive maintenance system 214 may generate alerts that indicate when there is an error or when maintenance is to be performed on a testing module. Predictive maintenance system 214 may monitor a level of material consumed by a testing module and generate an alert when the material is consumed above or below a threshold value. Predictive maintenance system 214 may receive an indication that a component or material within a testing module has been repaired or replaced, and may monitor the status of the component and generate an alert if the component is not performing as expected. Predictive maintenance system 214 may analyze various mobile device test and measurement results for trends and may generate an alert if an undesirable trend is detected before a threshold is reached.

With continued reference to FIG. 10, cosmetic inspection module 200 is configured to perform imaging and AI-based defect detection to identify physical defects on mobile devices. Cosmetic inspection module 200 may employ various imaging devices and lighting components to capture images of mobile devices under varying lighting conditions. Cosmetic inspection module 200 may utilize machine learning models trained on datasets containing images of mobile devices with various types of labeled defects and surface conditions to identify defects such as scratch patterns, dents, and debris on device surfaces. Additional details of the testing that may be performed by the cosmetic inspection module 200 is provided below.

Touch screen inspection module 202 is configured to inspect the display and touch functionality of mobile devices. Touch screen inspection module 202 may capture light from the display of a mobile device when the display is in an on-configuration to identify display-related defects such as dead pixels, color uniformity issues, and screen artifacts. Touch screen inspection module 202 may include a touch element configured to move across the display of the mobile device to test touch input functionality by comparing received inputs at the mobile device to expected inputs. Additional details of the testing that may be performed by the touch screen inspection module 202 is provided below.

Camera inspection module 204 is configured to test the performance of device cameras under various lighting conditions. Camera inspection module 204 may test a front aspect camera and a rear aspect camera of a mobile device. Camera inspection module 204 may include light sources positioned to emit light that may be captured by the cameras of the mobile device for testing camera functionality. Camera inspection module 204 may analyze captured images for quality factors such as focus accuracy, color balance, exposure, noise levels, and image sharpness. Additional details of the testing that may be performed by the camera inspection module 204 is provided below.

Audio inspection module 206 is configured to evaluate audio components of mobile devices. Audio inspection module 206 may test speakers used to emit sound by causing the speakers to emit a frequency or decibel of sound and measuring the emitted frequency, sound level, and other characteristics such as harmonic distortion and noise level. Audio inspection module 206 may test microphones or other sound detection devices of the mobile device by emitting frequencies and sound levels of sounds that are detectable by the microphone and comparing detected inputs to known emitted frequencies and sound levels. Additional details of the testing that may be performed by the audio inspection module 206 is provided below.

Wired communication inspection module 208 is configured to test USB and other wired port functionality across different device modes. Wired communication module 208 may comprise USB receiving sites to accommodate multiple devices simultaneously for device parallelization. Wired communication module 208 may include a USB controller with a custom printed circuit board configured to provide software control switching between different USB modes, such as charging mode, data mode, and debug mode, without unplugging the device from the USB receiving site. Additional details of the testing that may be performed by the wired communication module 208 is provided below.

Vibration testing module 210 is configured to test vibration-related components of mobile devices. Vibration testing module 210 may include a vibration testing apparatus having a membrane stretched across a cutout in a panel, with a sensor attached to a bottom aspect of the membrane. A mobile device placed on the membrane may be caused to vibrate, and the sensor may measure a force applied to the membrane caused by the vibration of the mobile device to determine a relative operational efficacy of a vibratory apparatus within the mobile device.

In conventional systems, automated device vibrator function testing is performed using audio chambers, using microphones for measuring audio signals emitted from the vibrations of the device. This indirect measurement of vibration may sometimes be inadequate, as it may be in a test environment where other noises (audio noise and vibrations produced by the test system or other external factors) that may occur in the same parts of the audio spectrum typical for such noises (e.g., approx. 100 Hz to 200 Hz) are present. A low signal-to-noise ratio must often be accepted, and such testing is consequently considerably impacted by external noise.

The present disclosure addresses the above issues by using a sensor, such as a piezo or accelerometer, instead of a microphone. The sensor may be attached to the bottom of a membrane stretched across a cutout in a panel of an audio chamber drawer. The surface area of the membrane may be greater than the size of the mobile device being tested, so that the devices under test can be put on the membrane without touching the panel. A mobile device placed on the membrane is thus effectively connected to the sensor on the opposite side of the membrane. Thus, kinetic energy produced by the vibratory apparatus may be measured more directly by the sensor. This signal, being measured directly, as opposed to measuring an audio side-effect through the air, results in a higher signal to noise ratio, making such measurements more stable or reliable.

The use of a flexible membrane to connect a mobile device to a sensor, instead of indirectly coupling the sensor with the mobile device (e.g., through a jig), may also serve to isolate the sensor from noise generated by other parts of the system or the ambient environment, e.g., by the moving parts of the test system (robot arm, device handlers, etc.) and vibrations coming in from the operation floor (e.g. forklifts driving by).Additionally, audio noises in the system environment do not stimulate sensors such as piezos or accelerometers to the same extent as microphones, further reducing the chances of making incorrect measurements of the vibrator strength and effectiveness. These advantages of the concept using a sensor mounted to a membrane is expected to significantly improve the reliability and precision of device vibration measurements.

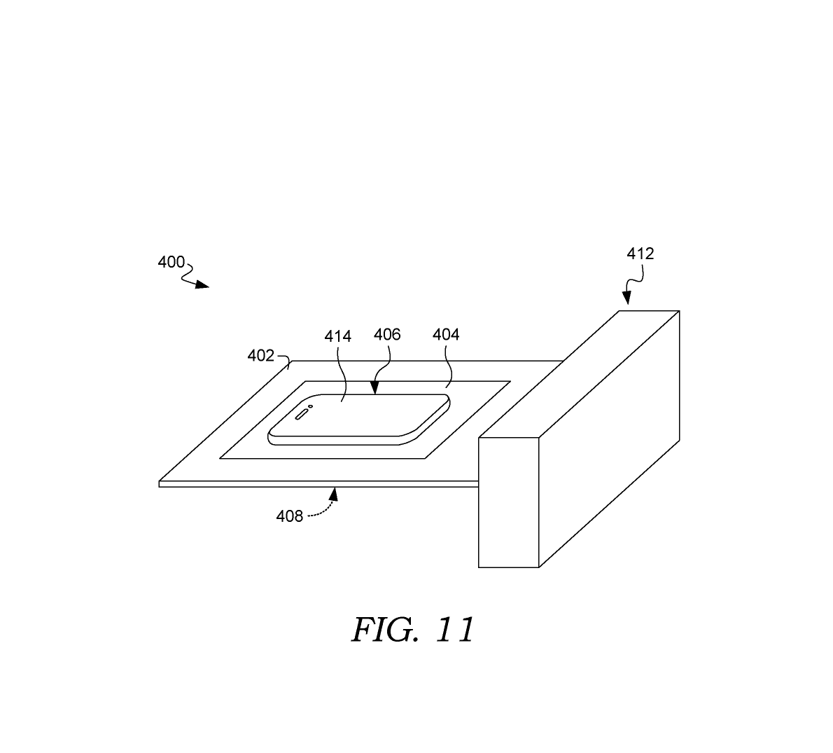

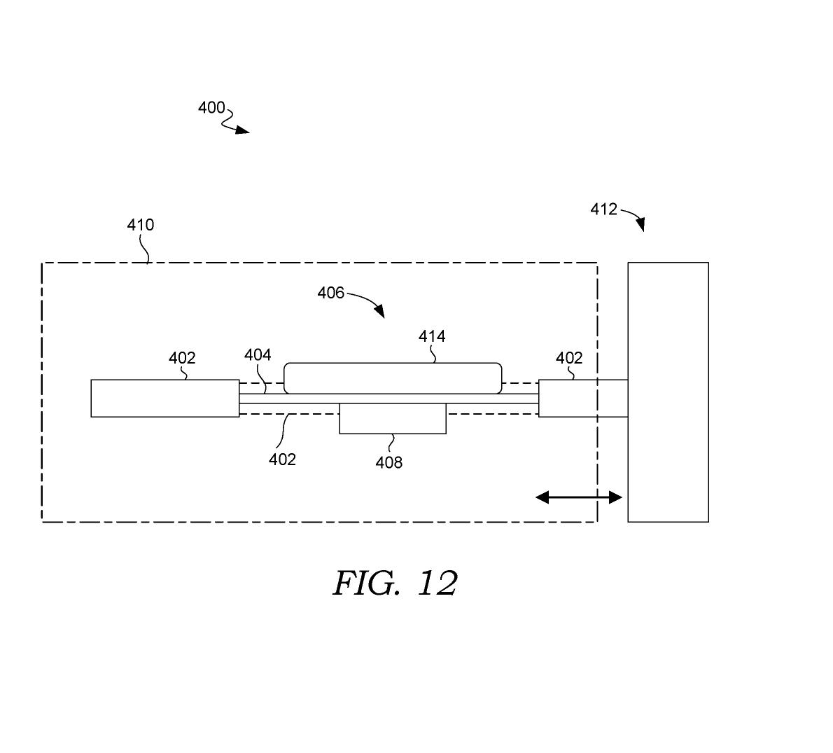

FIGS. 11 and 12 illustrate an example device for measuring the vibratory efficacy of a mobile device. Referring first to FIG. 11, a vibration testing apparatus 400 is illustrated in a perspective view. Vibration testing apparatus 400 includes a panel 402 having a generally flat rectangular form. Panel 402 defines a cutout in a central region thereof. A membrane 404 is disposed across the cutout defined in panel 402. Membrane 404 is stretched across the cutout to provide a flexible surface for supporting a mobile device 414 during vibration testing operations. A device placement area 406 is defined on an upper surface of membrane 404 within the cutout of panel 402. Device placement area 406 provides a designated region where mobile device 414 may be positioned for vibration testing.

With continued reference to FIG. 11, mobile device 414 is disposed on device placement area 406 atop membrane 404. A sensor 408 is attached to an underside of membrane 404 opposite device placement area 406. Sensor 408 may be a piezo sensor or an accelerometer configured to detect vibrations transmitted through membrane 404 when mobile device 414 vibrates. Sensor 408 is indicated by a dashed lead line in FIG. 12, denoting that sensor 408 is located beneath panel 402 and is not directly visible in the perspective view. A drawer mechanism 412 is coupled to panel 402 at a right side thereof. As seen in FIG. 12, drawer mechanism 412 enables panel 402 to slide in and out of a chamber 410 for placement and removal of mobile devices during testing operations. Bidirectional arrows adjacent to drawer mechanism 412 indicate the sliding direction of panel 402 relative to chamber 410. In examples, the chamber 410 can be the same chamber in the inspection and testing cell 102 used for audio testing. In other examples, the chamber 410 may be a separate dedicated vibration testing chamber.

As further shown in FIG. 11, the surface area of membrane 404 is greater than the size of mobile device 414 being tested. The oversized surface area of membrane 404 enables mobile device 414 to be placed on membrane 404 without touching panel 402. By providing membrane 404 with a surface area that exceeds the footprint of mobile device 414, vibration testing apparatus 400 ensures that mobile device 414 rests entirely on the flexible surface of membrane 404 rather than contacting the rigid structure of panel 402. The isolation of mobile device 414 from panel 402 enables vibrations generated by mobile device 414 to be transmitted through membrane 404 to sensor 408 without being attenuated or distorted by contact with panel 402.

Referring to FIG. 12, a cross-sectional side view of vibration testing apparatus 400 illustrates the structural relationship between panel 402, membrane 404, and sensor 408. Panel 402 extends horizontally across the figure and defines the cutout in a central region thereof. Dashed lines indicate non-visible portions of panel 402 that extend around membrane 404 within the cutout. Membrane 404 is stretched across the cutout of panel 402 and is shown as a thin horizontal layer spanning the opening defined by the cutout.

Device placement area 406 is defined on an upper surface of membrane 404. Mobile device 414 is disposed on device placement area 406 atop membrane 404. Sensor 408 is attached to an underside of membrane 404 directly below mobile device 414. The positioning of sensor 408 directly below mobile device 414 enables sensor 408 to detect vibrations transmitted through membrane 404 when mobile device 414 vibrates. Drawer mechanism 412 is disposed at side of panel 402 and includes a vertical support structure that serves as a front face of chamber 410 when drawer mechanism 412 is in a closed position.

In a vibration testing method, mobile device 414 is placed on membrane 404 so that it is effectively connected to sensor 408 on the opposite side of membrane 404. The connection between mobile device 414 and sensor 408 through membrane 404 enables kinetic energy produced by a vibratory apparatus within mobile device 414 to be transmitted directly to sensor 408. When mobile device 414 is caused to vibrate during testing operations, the vibrations generated by the vibratory apparatus within mobile device 414 are transmitted through membrane 404 to sensor 408. Sensor 408 measures the force applied to membrane 404 that is caused by the vibration of mobile device 414. A relative operational efficacy of the vibratory apparatus within the mobile device is determined based on the measured force.

As noted above, each cell 102 may include other testing apparatus to inspect and test other features of the mobile devices that may be expected to be processed by the system 100.

For example, one or more cells 102 may support technology to test touch screen styluses including active styluses. Active styluses may include styluses that contain electronic components for communication with a mobile device, such as styluses that transmit signals to the mobile device to indicate stylus position, pressure, or button state. One example of an active stylus is a stylus designed for use with certain mobile devices that supports stylus input. The active stylus may be stored within a compartment or slot in the mobile device housing when not in use, and may be extracted from the compartment for use as an input device. After the active stylus test is completed, the active stylus may be reinserted back into the mobile device. The reinsertion of the active stylus may be performed by the same automated mechanism that extracted the active stylus, or by a separate reinsertion apparatus. The reinsertion operation may position the active stylus at the opening of the stylus compartment in the mobile device and insert the active stylus into the compartment until the active stylus is fully seated. The extraction and reinsertion of the active stylus may enable comprehensive testing of active stylus functionality while returning the mobile device to a complete state with the active stylus properly stored within the device housing.

In another example, one or more cells 102 may support technology to test flip and fold devices. Flip devices may include mobile devices having a clamshell form factor where a display portion folds against a keypad or secondary display portion along a hinge axis. Fold devices may include mobile devices having a foldable display that folds along a hinge axis to reduce the overall footprint of the device when closed. Flip devices and fold devices may have different form shapes due to differences in the folding mechanism, display configuration, and overall device geometry.

The system may test flip and fold devices by actively opening and closing device lids in a defined manner. The defined manner of opening and closing device lids may specify the angle of rotation, the speed of rotation, and the number of open-close cycles to be performed during testing. The active opening and closing of device lids may be performed by a flip and fold jig within the inspection and testing cell. The flip and fold jig may engage with the device lid and apply controlled force to rotate the lid about the hinge axis between open and closed positions.

The active opening and closing of device lids may enable functional tests to be performed on the flip or fold device. The functional tests may include testing display functionality when the device is in open and closed configurations, testing hinge position sensors that detect the angle of the device lid, and testing automatic display activation or deactivation based on lid position. The functional tests may verify that the flip or fold device operates correctly as the device lid is moved through the range of motion supported by the hinge mechanism. The system may perform acoustic detection of lid opening and closing defects during flip and fold device testing. The acoustic detection may identify sounds generated by the hinge mechanism during lid opening and closing operations that indicate defects or wear in the hinge components. Defects in the hinge mechanism may produce sounds such as scratching sounds, clicking sounds, grinding sounds, or other audible indicators of mechanical issues. The acoustic detection may capture audio during lid opening and closing operations and analyze the captured audio to identify sounds that deviate from expected hinge operation sounds.

The system may perform force measurements during flip and fold device testing. The force measurements may quantify the force required to open and close the device lid through the range of motion supported by the hinge mechanism. The force measurements may identify hinge mechanisms that are too stiff, requiring excessive force to operate, or hinge mechanisms that are too loose, providing insufficient resistance to maintain the device lid in a desired position. The force measurements may be compared to expected force values for the device type to determine whether the hinge mechanism is operating within acceptable tolerances. The flip and fold jig may include a force sensor for measuring the force applied during lid opening and closing operations. The force sensor may be positioned to measure the force exerted by the flip and fold jig on the device lid as the lid is rotated about the hinge axis. The force sensor may provide continuous force measurements throughout the lid opening and closing operations, enabling characterization of the force profile across the full range of lid motion. The force measurements from the force sensor may be recorded and analyzed to identify variations in force that may indicate hinge defects or wear.

The flip and fold jig may include a microphone to test for noises created by the hinge. The microphone may be positioned to capture sounds generated by the hinge mechanism during lid opening and closing operations. The microphone may detect noises such as scratching sounds that may indicate friction or interference between hinge components. The microphone may also detect clicking sounds, popping sounds, or other audible indicators of mechanical issues within the hinge mechanism. The audio captured by the microphone may be analyzed to identify sounds that exceed acceptable noise thresholds or that exhibit frequency characteristics associated with hinge defects.

The flip and fold jig may be a universal jig configured to support different form shapes. The universal configuration of the flip and fold jig may enable the jig to accommodate both foldable devices and flip devices despite differences in form factor between these device types. Foldable devices may have a form shape where a flexible display folds inward or outward along a central hinge axis, resulting in a device that is approximately half the unfolded size when closed. Flip devices may have a form shape where a rigid display portion folds against a separate rigid portion along a hinge axis, resulting in a clamshell configuration when closed. The universal flip and fold jig may include adjustable components or interchangeable fixtures that accommodate the different form shapes of foldable devices and flip devices. The adjustable components may enable the jig to grip and manipulate device lids of different sizes, shapes, and hinge configurations. The universal configuration may reduce the need for device-specific jigs and may enable the inspection and testing cell to process a variety of flip and fold device types without requiring jig changes or mechanical reconfiguration.

The flip and fold jig may require precise positioning of devices with the center of the hinge in mind. The precise positioning may align the center of the device hinge with a rotation axis of the flip and fold jig mechanism. When the center of the device hinge is aligned with the rotation axis of the jig mechanism, the force applied by the jig to open and close the device lid may be applied in a manner that corresponds to normal lid operation. Misalignment between the device hinge center and the jig rotation axis may introduce additional forces or moments that do not correspond to normal lid operation. The precise positioning of devices with the hinge center aligned may avoid impacting the force measurement accuracy. When the device hinge center is misaligned with the jig rotation axis, the force measurements may include components that result from the misalignment rather than from the hinge mechanism resistance. The misalignment-induced force components may cause the force measurements to deviate from the actual force required to operate the hinge mechanism. By positioning devices with the center of the hinge precisely aligned with the jig rotation axis, the flip and fold jig may obtain force measurements that accurately reflect the mechanical characteristics of the hinge mechanism without contamination from positioning errors.

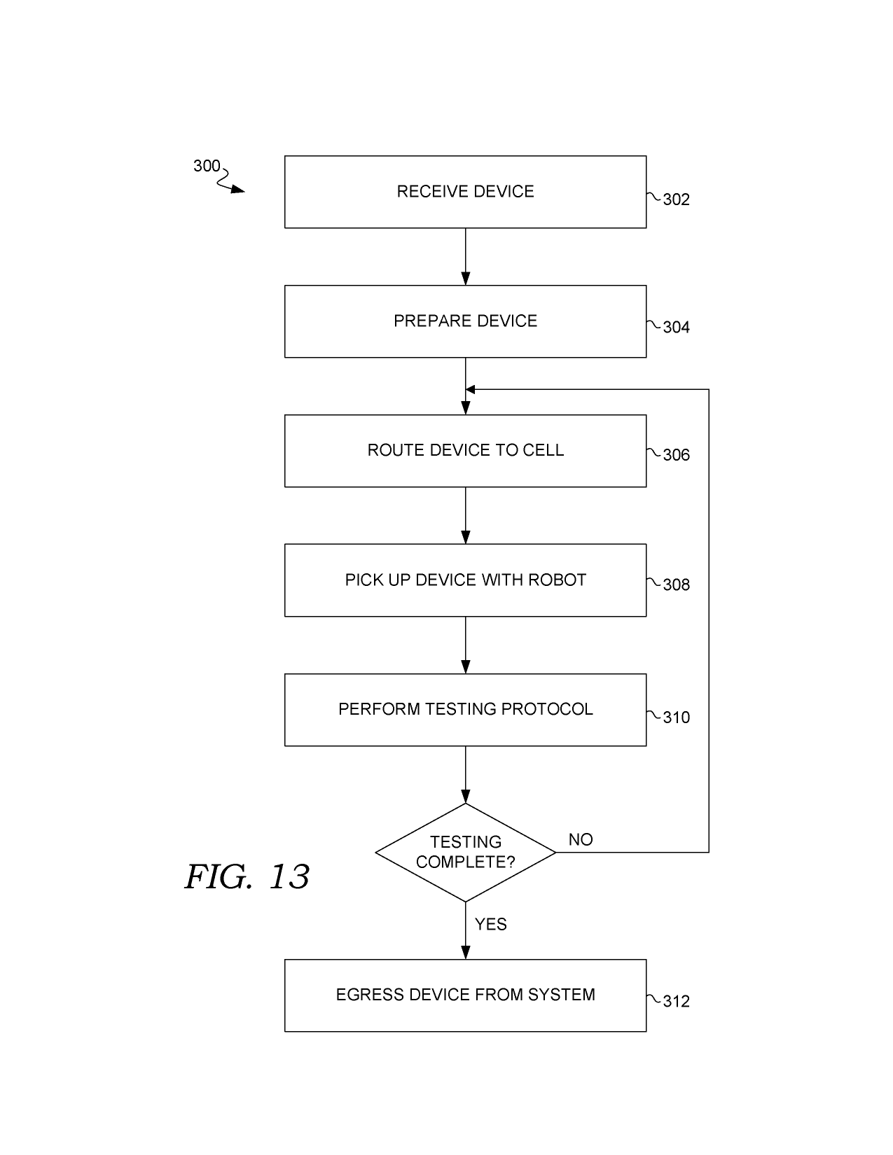

Referring to FIG. 13, a method 300 for processing a mobile device through the system 100 is illustrated. Method 300 includes a plurality of steps that may be performed sequentially as a mobile device traverses the system 100 from ingress to egress. Method 300 may be performed by the various components of the automated mobile device processing system including the receiving station 104, the preparation station 106, and the plurality of inspection and testing cells 102 arranged in serial configuration.

Method 300 includes a step 302 of receiving a device, which may be performed at a receiving station such as receiving station 104. During step 302, shipment and device barcodes may be scanned for data validation and cross-checking against the backend platform. The barcode scanner at the receiving station may scan barcodes on shipping containers and on individual mobile devices to identify the devices and validate the devices against expected shipment manifests stored in the backend platform. During step 302, device identification labels may be printed on demand using the label printer at the receiving station for manual application to mobile devices by an operator.

At step 304, the device is prepared for testing. This step may be performed at one or more of a receiving station such as receiving station 104, a preparation station such as preparation station 106, and or an auto prep cell such as auto prep cell 150. During step 304, the device may be identified by IMEI or MSN through a USB or lightning connection established between the mobile device and the preparation station or automatic preparation cell. The device identification may enable the automated mobile device processing system to associate the mobile device with device records stored in the backend platform and to retrieve device-specific configuration information for subsequent processing operations. Step 304 may include charging device batteries in a managed manner, where charge levels are monitored during charging and the charging process is terminated once a minimum charge level sufficient to complete subsequent inspection and testing operations is reached. Step 304 may include performing data wipes to remove unwanted data from device memory, which prepares the mobile device for subsequent processing by removing user data that may interfere with testing operations or present privacy concerns. Step 304 may include updating device software or flashing the mobile device to a defined firmware version that is compatible with the testing applications and testing procedures used by the automated mobile device processing system. Step 304 may include unlocking devices that are locked to a particular user account or configuration, removing user account associations or device locks that would prevent the automated mobile device processing system from accessing device functions required for inspection and testing. Step 304 may include checking carrier lock status to determine whether the mobile device is locked to a particular wireless carrier, which may affect the resale value or redistribution options for the mobile device. Step 304 may include checking device stolen status by querying the backend platform or external databases to determine whether the mobile device has been reported as stolen, with devices identified as stolen being flagged for removal from the processing line and handled according to applicable procedures for stolen property. Step 304 may include installing and launching a mobile device test application on the mobile device. The mobile device test application may be executed on the mobile device during subsequent inspection and testing operations performed by the inspection and testing cells, coordinating with the inspection and testing equipment to perform operations such as displaying test patterns, capturing images, recording audio, and reporting test results.

At step 306, the mobile device is routed to one of the inspection and testing cells, such as inspection and testing cell 102, in the system. During step 306, the mobile device may be placed on a conveyor, such as the feeder conveyor 108, and conveyed to the device pick position within the inspection and testing cell. The load manager may coordinate the operation of the conveyor segment to transport the mobile device to the desired cell’s device pick position where the robot arm may pick up the mobile device for inspection and testing operations.

At step 308, the robot within the inspection and testing cell picks up the mobile device from the conveyor system. During step 308, the conveyor segment may be stopped intermittently while the mobile device is at the device pick position. The intermittent stop of the conveyor segment may be for a brief duration (e.g., approximately 2 seconds), during which the exact position of the mobile device may be measured. The position measurement may enable the robot arm to determine the precise location and orientation of the mobile device on the conveyor segment. Following the position measurement, the robot arm may pick up the mobile device with high precision for carrying out testing and analytics operations within the inspection and testing cell.

At step 310, the cell performs a testing protocol on the mobile device, in accordance with instructions received from the load manager. The testing protocol may include performing one or more of the tests described above. The system may grade the tested features of the device and upload the data to the load manager, which may then convey the data to the backend platform.

As discussed previously, during the testing of a mobile device within a cell, the conveyor segment of that cell may still be in operation to convey other mobile devices through the system. The continued movement of the conveyor segment may allow the conveyor segment to carry other devices that have already been tested by systems upstream in the device processing line or that are to be tested by systems downstream in the device processing line. The continued conveyor movement enables a continuous flow of devices through the device processing line even while individual devices are being tested within an inspection and testing cell.

After a cell performs the testing protocol instructed by the load manager, if additional testing by another cell is required, then steps 306, 308 and 310 can be repeated so that a second cell can receive the mobile device and perform its testing protocol, with the robot placing the device on the cell’s conveyor segment 110, and the load manager instructing the various conveyor segments to transport the device to the next cell designated for testing that device. These steps can be repeating until all desired testing is completed. At step 312, once all testing by all cells is completed, the mobile device can be egressed from the system for post-test processing. For example, during step 312 the mobile device may be returned to the conveyor segment and transported to an egress position. The robot arm may place the mobile device back onto the conveyor segment after inspection and testing operations are complete. The conveyor segment may transport the mobile device from the inspection and testing cell to the egress position of the device processing line. From the egress position, the mobile device may be removed from the device processing line for subsequent handling based on the grade assigned during step 320.

Non-limiting examples of the various testing apparatus and features that an inspection and testing cell may include are provided below:

### Example cosmetic inspection module

In some aspects, the cosmetic inspection module visually inspects the mobile device. In an aspect, this is performed as the mobile device is positioned in a specific position within the cell. In one example case, the inspection is performed while a display of the mobile device is in an off-configuration. For instance, an “off-configuration” for the mobile device display can include a state in which the display screen is not actively showing visual content. This can occur when the mobile device itself is powered off, or when the device is on but the display is turned off. A device display “on-configuration” can include a state in which the display screen is illuminated to actively show visual content, such as images, text, or other visual elements.

To do so, one example cosmetic inspection module component includes an area camera and/or a line scan camera, which captures images of the mobile device under varying lighting conditions while the device is present within the cosmetic inspection zone of the cell, or otherwise being acted on by the cosmetic inspection module. There may be one or more line scan cameras. An area camera or line scan camera may include a system comprising one or more lighting components and one or more imaging devices. In an aspect, the lighting components are static lighting components. The lighting components may be aligned with the position of the mobile device within the cosmetic inspection zone. These lighting components may provide various lighting conditions so that the one or more imaging devices can image the mobile device under different lighting conditions. The lighting and imaging assists in identifying physical defects that may be present on mobile devices.

In some aspects, various lighting conditions that may be used in a cosmetic inspection module. Simulated daylight conditions may help identify surface defects like scratches and smudges. Low light conditions may help identify subtle dents or surface irregularities that are less visible under bright light. Diffuse light, which is relatively softer and more evenly distributed, may reduce shadows and highlight surface texture, making it easier to detect uniformity issues. Directional light, coming from a specified angle, may create shadows and highlights that accentuate surface defects like scratches and bumps. Colored light within the visible electromagnetic spectrum, which may include different color temperatures, such as warm (e.g., 620 to 750 nm) or cool lighting (e.g., 450 to 500 nm), can affect the appearance of the surface and help identify color inconsistencies or discoloration. Strobe light may be useful for inspecting moving parts or detecting transient defects. Polarized light, which reduces glare and reflections, may enhance the visibility of surface defects on glossy or reflective surfaces. Additionally, infrared light (e.g., 780 nm to 1 mm) may be used to detect heat patterns and underlying defects not visible to the naked eye. Ultraviolet light (e.g., 10 nm to 400 nm) may be used to highlight surface contaminants and defects through fluorescence, for instance. These varying lighting conditions may be used individually or simultaneously, or in combination to provide a comprehensive inspection of the mobile device’s surface.

Light diffraction or other distortion from the mobile device may be indicative of a defect in the mobile device surface. As will be further discussed, images captured using the imaging devices of the line scanners may be provided to an AI-based system for identifying defects.

The AI-based defect detection feature may one or more machine learning models. In an aspect, the AI feature uses multiple models, where each model is trained on a different surface type. In an aspect, the feature includes a model trained to determine the surface type of the mobile device. In general, the model(s) may receive images from the imaging devices under one or more of the lighting conditions and provide one or more outputs identifying potential defects on the surface of the mobile device. In an aspect, the one or more models identify light diffraction or other light distortion at the surface of the mobile device to determine potential defects, such as a scratch pattern or dent. Another example defect might include debris remaining on the device. A scratch pattern generally includes a single or multiple scores on the surface of the mobile device. These scores may be superficial or may have removed material from the surface. The characteristics of a scratch pattern may include attributes such as depth, length, and other relevant characteristics. A scratch pattern may also be inclusive of chips or gouges within the surface of the mobile device.

As an example, the AI-based defect detection feature may utilize various types of machine learning models, including convolutional neural networks (CNNs), support vector machines (SVMs), decision trees, or the like. These models may be trained on datasets containing images of mobile devices with various types of labeled defects and surface conditions. For instance, a model trained to identify the surface type of a mobile device may analyze features such as texture, reflectivity, and color to determine whether the surface is glass, metal, plastic, or another material.

In some aspects, there may be one or more models specifically trained to identify defects on different surface types. For example, a CNN trained on glass surfaces may be suitable for identifying scratches, smudges, and the like, while a model trained on metal surfaces may focus on identifying metal scratches, dents, corrosion, discoloration, and the like. Additionally, there may be multiple models for identifying defects on various surface types of mobile devices, such as glass, metal (such as aluminum, titanium, steel, and so forth), plastic, ceramic, carbon fiber, and the like found on a variety of mobile devices, such as smartphones, tablets, smartwatches, and the like.

In an aspect, the cosmetic inspection module may include an acoustic device for determining additional information corresponding to a scratch pattern. In an example, the acoustic device comprises an acoustic sensor and an acoustic stylus. The acoustic stylus may be configured to contact a scratch on the mobile device, and the acoustic sensor may detect the sound emitted from the stylus when it contacts the scratch. This sound may indicate the depth or another characteristic of the scratch pattern.

As an example, the acoustic stylus may be a tool designed to interact with the surface of the mobile device. It may emit sound waves when it contacts the surface. These sound waves are then absorbed or reflected differently depending on the presence and characteristics of a scratch pattern as the stylus contacts the scratch pattern when moved across the surface. For example, a deeper scratch may produce a different sound signature compared to a superficial one. A labeled dataset of sounds emitted from various scratch patterns may be used as a baseline, comparison, or training data for determining data about the scratch pattern from an emitted sound. In an aspect, the stylus comprises a material, such as steel. The stylus may protrude to a point. In aspects, the stylus is relatively longer in one dimension compared to another dimension, such that the stylus produces a flat surface.

As an example, the acoustic sensor may be a device that detects sound waves and converts them into electrical signals. This may be a microphone for example. Some acoustic sensor systems may comprise capacitive, piezoelectric, triboelectric effect, mechanisms, or another like mechanism. The microphone may be tuned or otherwise configured to pick up sound waves in a frequency emitted by the stylus when contacting the surface the mobile device or scratch pattern.

In an aspect, a mobile device is assigned a grade based on information determined from the cosmetic inspection module. In an aspect, the grade may be based on data from another cell in the processing system. As an example, the grade may be based on physical defects determined from the cosmetic inspection module, such as scratch patterns (including the location of scratches). Grades may be assigned based on other information as well, including age of the device, the battery operability (e.g., health or performance), water damage, button functionality, and the like. Based on these example conditions, or other conditions, a grade may be assigned by comparing the data to a grading scale. In an aspect, the grading scale is determined using generative AI. In an aspect, the condition of the device is provided to a generative AI model, and the model is prompted to assign a grade.

### Example touch screen inspection module

In an aspect, the touch screen inspection module is separate from the cosmetic inspection feature. The touch screen inspection module may be upstream or downstream of the cosmetic inspection feature within the cell, e.g., the touch screen inspection module may be employed before or after the cosmetic inspection feature within the cell. In an aspect, the touch screen inspection module components may perform their functions immediately follows the cosmetic inspection feature components performance of their functions. In other aspects, the touch screen inspection module may be combined with the cosmetic inspection feature; for example, the touch screen inspection module may use one or more of the same components when performing certain functions.

In an aspect, the touch screen inspection module comprises an imaging device configured to capture light from the display of the mobile device when the display is in an on-configuration. The imaging device may be designed to capture different display patterns of the mobile device display, which can include various colors, gradients, and imagery to highlight specific issues such as light bleeding, bright spots, dead pixels, and screen burn.

As examples, the patterns may include solid colors such as red, green, blue, white, and black, which can help identify issues like dead pixels, stuck pixels, and color uniformity problems. Gradients, which are transition areas between colors, may reveal issues with color banding, gradient uniformity, and subtle screen artifacts. Checkerboard patterns, such as black and white squares, can highlight issues with pixel alignment, screen uniformity, and contrast, among other physical defects, such as superficial or non-superficial scratches or cracks in the screen. Horizontal and vertical lines displayed across the screen may help detect alignment issues, screen tearing, and inconsistencies in pixel response, while also possibly identifying superficial scratches or cracks. Text patterns, displaying text in various fonts and sizes, can help identify issues with text clarity, sharpness, and rendering for example. Geometric shapes, such as circles and squares, may reveal distortions, alignment issues, and geometric inaccuracies for example. Additionally, dynamic patterns (e.g., animations) can help identify issues with refresh rates, motion blur, and screen responsiveness, for example. These display patterns may be used individually or in combination, simultaneously or sequentially.

An AI-based defect detection feature similar to those previously discussed may be used to identify defects from images captured of the screen when in the on-configuration. For instance, trained CNNs or other image processing models may be employed. Such models may be trained on datasets comprising images of mobile device displays with various types of defects, such as dead pixels, color uniformity issues, and screen artifacts. These datasets may include labeled examples of different defect types under various lighting conditions and display patterns.

In an aspect, the touch screen inspection module may further comprise a processor configured to combine the outputs of the cosmetic inspection feature and the touch screen inspection module. In general, the touch screen inspection module may include, or otherwise be in remote communication with, a processor that is configured to generate a composite image using images captured under external lighting conditions with the screen in an off-configuration and images captured of the screen when it is in an on-configuration.

For example, the processor may access and employ one or more image processing algorithms, such as an alpha blending or image stitching algorithm, to align and merge images, creating a composite image that integrates both sets of data. This composite image may provide a comprehensive view of the device itself or a representation of the device, indicating both physical and display-related defects. The combined data may include metadata such as reflectivity, contrast ratio, and defect location as previously discussed, which may be accessible by interacting with the indications, for example. The touch screen inspection module may comprise an output display device for rendering the composite image. In aspects, the display cell stores or communicates the composite image for display at a remote display device. As previously noted, the composite image may be used for grading.

In an aspect, the touch screen inspection module may include a touch element configured to move across the display of the mobile device. That is, the touch element may be configured to contact the display of the mobile device and interact with the contact surface, either by moving the touch element relative to the display, moving the display relative to the touch element, or a combination of both, all of which are intended when describing movement of the touch element. The touch element may move across the display using an input pattern. This pattern may be recognized by an application executed on the mobile device.

In a specific example, the input pattern comprises two diagonal movements across the display, e.g., from corner to corner, and a movement along each perimeter edge of the display. This pattern helps the touch element interact with a representative portion of the display, even in cases where the entire surface of the display is not contacted by the touch element. In aspect, the touch element comprises one or more touch surfaces, which may further allow for multi-touch interactions, such as pinching, pulling, and multi-touch directional movement. In aspect, the touch screen inspection module uses a specialized stylus configured to interact or communicate with the mobile device as the touch element or part of, e.g., a stylus designed as an input device for a particular type of display, device, program, application, or the like.

### Example camera inspection module features

In general, the camera inspection module may be configured to test one or more cameras of a mobile device. In an aspect, the camera inspection module may be designed to assess a front aspect camera and a rear aspect camera of a mobile device. A camera may be tested while the device is maintained in a defined position within the cell. The camera inspection module may comprise a light source that emits light that may be captured by one or more cameras for testing the camera. For example, light sources used for testing mobile device cameras may emit various types of light to simulate different lighting conditions such as visible light, e.g., from red to violet; IR light for testing IR sensors of the camera, including night visions sensors; and UV light, and any pattern thereof in a direct or diffuse manner.

In an aspect, the camera inspection module within the cell may comprise two separate light sources. The light sources may be positioned in substantially opposite directions, e.g., the first light source emits light in the direction of a second light source and the second light source emits light in a direction of the first light source. The two or more lights may be immediately across from one another, e.g., the light is emitted along the same theoretical plane extending through light emitted by the first light source and the second light source. In another aspect, the two or more light sources are offset, e.g., light emitted from a first light source travels along a different theoretical plan than light emitted from the second light source.

In an aspect, a light box, and in some cases two different light boxes, may be used for the front and rear aspect camera inspections. The light boxes may provide controlled lighting conditions to ensure consistent and accurate testing of the camera functionalities. For example, the light boxes may simulate various lighting environments, such as bright daylight, low light, and diffuse light, to evaluate the cameras’ performance under different conditions. The inspection process may involve capturing images and videos using both the front and rear cameras, and analyzing the quality of the captured media. As an example, the quality of a captured image or video may be determined by analyzing factors such as focus accuracy, color balance, exposure, noise levels, and image sharpness, among others. Additionally, AI-based models can be used to detect and analyze defects in the camera modules, such as lens scratches, sensor malfunctions, alignment issues, and the like. Using multiple light sources or boxes helps test cameras with a single grip of a jig holding the device, reducing the amount of repositioning required by the mobile device and creating a smoother, more efficient travel path through the cell. In an additional aspect, a camera test pattern is illuminated either by controlled light from a light box or illuminated indirectly by a diffuse light source. The pattern may be a contrast-rich geometrical shape, on which the camera shall focus either automatically (for testing the device auto focus feature), or given by the defined distance in which the device is positioned for the test and in which it shall focus given its specified characteristics (fixed focus test). The pattern used further allows to analyze a picture taken by the camera under test for geometric and perspective distortion.

As will be discussed, the camera inspection module may work in coordination with an application on the mobile device, which may instruct the functionality of the camera input or output (such as a flash) components.

### Example audio inspection module

In some aspects, the audio inspection module is configured to test the audio functionalities of the mobile device. This may include testing the speakers used to emit sound, whether the sound is within or outside a human-detectable frequency (e.g., 12 Hz to 20 kHz). In some aspects, other audio components are tested as well, such as various points or other audio output devices, such as USB-C or 3.5mm jack. In such case, speakers may be connected via the points and the speaker sounds may be tested. In an aspect, sound emitted by a speaker with remote connectivity using wireless techniques already described may be tested.

In an aspect, the audio inspection module tests the speaker or other audio outputs by causing them to emit a frequency or decibel of sound and measuring the emitted frequency, sound level and/or other characteristics, such as harmonic distortion and noise level. Algorithms may be used to analyze the frequency response and determine whether the sound output meet threshold values. As an example, frequencies up to 20 kHz may be measured. As an example, sound volumes may be measured up to 115 dB. These are just some examples, and the mobile devices may be tested by measuring emitted sounds at increased frequencies or decibels, among other possible metrics for measuring audio output.

In an aspect, the audio inspection module tests a microphone or other sound detection device of the mobile device. Similarly, audio ports and other audio components may be tested using an external audio device connected, directly by bus or wirelessly, to the audio device. In such cases, the audio inspection module may emit frequencies and sound levels of sounds that are detectable by the device’s microphone or other sound audio input components (e.g., 30 dB to 130 dB, and 20Hz to 20 kHz). The detected inputs can be compared to the known emitted frequencies and sound levels to determine the functionality of any audio input components.

In an aspect, the audio inspection module may include an isolated sound chamber for testing audio functionality as described, such as the device’s microphones and speakers.

As will be discussed, like other cells and functionalities, the audio inspection module may work in coordination with an application on the mobile device, which may record inputs from audio input components and instruct the functionality of audio output components.

### Example wired communication inspection module

In some aspects, the cell comprises a wired communication inspection module for controlling the device by a system computer through the device USB port to carry out commands and functions, including but not limited to controlling the device’s user interface (e.g., the device display), executing a device data wipe or interacting with the device operating system (e.g. Android or iOS).

The wired communication inspection module may comprise any number of USB receiving sites to accommodate multiple devices simultaneously, e.g., for device parallelization to achieve the specified takt time. One example implementation uses USB slots (which may also be referred to as jigs). The number of receiving sites may be proportional to a length of time to test a mobile device connected to one of the USB receiving sites. For example, the number may be such that devices complete testing at a predetermined time interval.

In an aspect, a camera is positioned to view the display of one or more devices connected to the USB receiving sites. In an aspect, the camera is a low-resolution camera. The camera may capture outputs on the display of the device during testing. These cameras may recognize whether the expected output is visible on the screen, providing visual confirmation of the device’s response to the tests. To provide an example, a low-resolution camera may capture images at or within a resolution of 60 to 150 PPI (pixels per inch). In an aspect, each USB testing site has a corresponding camera. The low-resolution provides enough information to determine whether the expected output is visible at the mobile device display, while reducing the amount of processable data across the system or cell generally.

The wired communication inspection module may also include a USB controller with a custom PCB (printed circuit board). The custom PCB is configured to provide software control switching between different USB modes. As examples, some modes include charging mode, data mode, and debug mode. Other modes may also be available, for example, based on the hardware or software of the type of mobile device. The software controlled mode switching may be performed without unplugging the device from the USB receiving site. In an aspect, the model is switched to a mode that is configured by the device manufacturer or an application to require the device to be plugged, unplugged, or switched between these states without the device being plugged in, unplugged or switched respectively. In an aspect, this software control switching PCB (which is intended to include one or more PCBs operating within a system) allows for full bandwidth charging, full bandwidth data transfer, and can also serve as an injection vector for a keyboard or mouse to instruct the device. The screen output can be used as a feedback loop to verify the device’s response. The PCB for devices that support HDMI (high definition multimedia interface) output using the USB DisplayLink Protocol (DPLT) may intercept the display output, read the software running on the board, and mirror what is visible on the screen. By utilizing touch injection over USB, the system replicates the necessary touch interactions to activate developer mode, fully automating the process and standardizing it across diverse devices.

### Example integrated mobile device application

In some aspects, an application installed on the mobile device may be integrated with the overall processing system to facilitate various inspection, testing, and repair processes, among other processes. In general, the application may be a software program designed to perform specific tasks on a mobile device, e.g., instruct a mobile device to perform a set of operations. The application may be a program that interacts with the device’s hardware and software components to execute functions such as data collection, communication, and control, among other possible functions. The application may be used in coordination with any of the systems described previously.

In an aspect, the application may be preloaded and executed on the device. This may be done before it enters one or more of the processing cells. Communication between the system and the device may occur via a direct communication bus or may use other wireless techniques, for example, WiFi, cellular, NFC (near field communication), Bluetooth, infrared (IR), Zigbee, Z-wave, and so on.

In some cases, the application may instruct the device to perform operations detectable by the mobile device processing system, such as displaying a particular image, pattern, or dynamic display, or producing a sound at a specific frequency, decibel level, or combination or range thereof.

In an aspect, a cell, such as the touchscreen inspection system of the cell, may contact the mobile device touchscreen at specific locations and times, and moving in particular patterns as discussed previously. The application may receive feedback from the touchscreen input. This received input data may be compared to determine if the received inputs at the mobile device match the inputs by the cell making contact with the touchscreen. If there is a match, this may indicate that the touch screen inputs are functioning correctly or as intended. If there is no match or only a partial match, then there may be an issue with the touch screen input.

The application may also instruct the device to enter an on- or off-configuration or instruct the display to enter an on- or off-configuration, e.g., by turning the display off or the device off. The application may initiate the recording of data from certain input devices of the mobile device, such as the press of an input button, interaction with the touch screen display, or any other input at the mobile device or at an external input device in direct or wireless communication with the mobile device. In some cases, there may be a predetermined pattern of expected inputs to be received. For example, at a particular time or within a specific cell, the application may expect to receive an input via the touchscreen or other input devices, such as the patterns previously described.

Furthermore, the application may instruct the device to display specific images to aid in determining physical defects in the display or the display device material. In some cases, the application may instruct the mobile device to display a unique barcode, such as a 2D (two-dimensional) or 3D (three-dimensional) barcode, with a unique identifier for the device. These barcodes may be recognized by one or more cells. In aspects, a unique identifier for the device may be mapped within structured data corresponding to the device. In an aspect, the application may instruct the device to capture an image. The image capture instructions may include capturing an image using one or more cameras, such as a camera on a front aspect or a camera on a rear aspect of the device, or any other camera or remote camera. The application may further modify optical or digital zooming, modify the exposure time, or perform another like camera action.

### Example device age inspection

In an aspect, the information determined from any of the systems or methods described herein can be used to determine, or otherwise assign, an age to a mobile device. In some aspects, determining the “age” of a device may involve analyzing composite images and using software processing to assess wear and tear on various hardware components, such as the battery.

For instance, the composite images may provide an understanding of the device’s physical and display-related defects. Software processing may be used to analyze these composite images and assess the condition of the device’s hardware. Additionally, determining the age of the device may include software algorithms designed to evaluate the performance and health of the device’s hardware components. One such example is the battery. This may involve analyzing usage data, charge cycles, and battery capacity over time to determine the extent of wear and tear on the battery. The software may also assess other internal components, such as the processor and memory, by evaluating performance metrics and identifying any signs of degradation. A grade may be assigned to, or otherwise be based on, the device based on the data corresponding to the device’s hardware and software.

### Example predictive maintenance system

In some aspects, a predictive maintenance system may comprise computer-implemented instructions that monitor and maintain aspects of the mobile device processing system, including one or more cells therein. In an aspect, the predictive maintenance system may receive data from different systems as input data. In some aspects, data may be received manually. In an aspect, the predictive maintenance system outputs information about the status or maintenance requirements of the cell and its system components. In aspects, the system may provide alerts that indicate when there is an error or when maintenance is to be performed. The predictive maintenance system helps each of the systems within the automated mobile device processing system operate efficiently and effectively. The predictive maintenance system helps prevent errors, reduce downtime, and maintain the quality and reliability of the processing system. The predictive maintenance system may provide status data or alerts on any of the system components.

In an aspect, the predictive maintenance system may also monitor the pressure and flow rate of the air delivery system, and may generate an alert if the pressure or flow rate is outside of specified parameters.

In an aspect, the predictive maintenance system may monitor the cosmetic inspection feature or components thereof. For example, the predictive maintenance system may monitor the imaging devices, lighting components, or the AI-based defect detection feature. For instance, it may track the performance of the area cameras or line cameras and lighting components to determine whether they provide consistent imaging under various lighting conditions. The predictive maintenance system may generate an alert upon detecting a lighting component is not emitting light or is not emitting light within a specified threshold parameter value.

In an aspect, the predictive maintenance system may monitor the touch screen inspection feature or components thereof. For example, the imaging devices may be monitored.

In an aspect, the predictive maintenance system may monitor the camera inspection feature or components thereof. For example, the predictive maintenance system may monitor the light sources used to test the one or more cameras of mobile devices. For example, the predictive maintenance system may generate an alert upon detecting one or more light sources is not emitting light or is emitting light outside of a specified threshold parameter value. The system may track the performance of the light boxes by tracking whether the light boxes provide consistent lighting conditions for accurate camera testing.

In an aspect, the predictive maintenance system may monitor the audio inspection feature or components thereof. For example, the predictive maintenance system may monitor speakers, microphones, or other audio components. For instance, the predictive maintenance system may monitor the audio outputs of sound emitting components within the audio inspection feature and provide alerts if such components are outside of threshold frequency or decibel ranges.

In an aspect, the predictive maintenance system may monitor the USB ports of the wired communication feature or components thereof. For example, the system may track the performance of the USB ports to determine whether the ports provide consistent connections for charging, data transfer, or other modes. The system may also monitor the cameras to determine whether the cameras are viewing screen outputs during testing.

As noted, as in general, any of the system components may be monitored by the predictive maintenance system. Monitoring may include reading data received from the cell or components and providing the data for display at a display device in communication with the mobile device processing system. In an aspect, the predictive maintenance system monitors a level of material consumed by a cell or component of the processing system and generates an alert when the material is consumed below a threshold value. In an aspect, the predictive maintenance system receives an indication that a component or material within a cell has been repaired or replaced. The predictive maintenance system may monitor the status of the component and generate an alert if the component is not performing as expected (e.g., is performing outside of threshold parameters). In an aspect, the predictive maintenance component may generate an alert based on a specified time passing after receiving an indication that a component or material has been repaired or replaced. In an additional aspect, the predictive maintenance system analyzes various mobile device test and measurement results for trends, and may generate an alert if an undesirable trend (e.g., one that would be considered a cause of invalid test results) is detected before a threshold is reached.

The system may include an automated cosmetic inspection feature in addition to those discussed above capable of inspecting one or more mobile devices. In an example, the cosmetic inspection feature tests all sides of a mobile device. For instance, for a mobile device having six sides, each of the six sides, including the four edges of each of the sides, may be tested sequentially.

In an aspect, the cosmetic inspection feature may identify a scratch pattern, and sort mobile devices into categories based on the scratch pattern. In aspect, the cosmetic inspection feature outputs a grade for a mobile device. In an aspect, the mobile devices are imaged. Images (photographs or video for example) taken during the inspection may be uploaded to backend systems for reference, along with the result data.

Functions performed by the cosmetic inspection feature may involve imaging devices with cameras or other sensor technology under defined illumination conditions, such as those previously described. The images taken may be inspected using an AI system. The inspection results may be parsed according to customer-specific definitions to determine true defects from non-critical observations on the device surfaces. Cosmetic grades for device results can be applied according to the result details, which may be uploaded to the system for reference and may be used by other cells within the mobile device processing system.

The system may include an automated display testing feature. In an example, the automated display testing feature may be configured to support flat, curved, or edged displays, and provide both inline and offline display analytics. The automated display testing feature may utilize product-specific test patterns and tests and grades displays for colors, brightness, and defects in various clusters, such as burn-in, light leakage, white dot, hot pixel, dark pixel, dark region, lines, and the like. The test and grading parameters may be product-specific.

Test data, including images and numerical results, may be subjected to data analytics and stored for reference by other cells. In an aspect, the display testing system comprises a controlled test environment, which may include light shielding, positive air pressure, air knives for active dust avoidance during the test, or the like. On example camera equipment includes the Matrix Vision mvBlueCOUGAR-X 107b with a high dynamic sensor, Sony IMX428.

In an aspect, iOS and Android devices, or another device type, are identified by the ID shown on the display of the mobile device, are taken into a test jig in the cell, and are moved to the test position. High-resolution cameras may take pictures of device displays while showing a product-specific pattern. Analytics software may review the pictures to detect failures, which are then graded according to customer-specific settings. Mobile devices may be automatically conveyed to the cell’s egress position for further processing by other cells or equipment. Display pictures taken may be uploaded as reference data, along with detailed test results, and may be used by other systems in the cell or connected to the cell.

Aspects of other features described, such as the cosmetic inspection feature, may be suitable for use by the automated display testing feature. In an aspect, locations of cosmetic defects identified may correlate with location of display defects, indicating that what appears to be a display defect might be caused by the cosmetic defect, and shall be reconsidered given the correlation of defect positioning. In the example described, the display defect analytics applies rules to identify specific characteristics to conclude if the specific cosmetic defect is indeed causing the display anomaly under suspicion.

The functionality of the automated display testing feature may comprises moving a stylus, e.g., capacitive, along a predefined drive path covering outer edges and the mobile device touchscreen. This may use a preset touch force and stylus speed. The touchscreen of the mobile device senses the stylus as it moves across areas and reports the areas touched as a test result. The touch force applied to each of the areas may be recorded for applicable devices. Multi-touch functionality may be tested by moving two or more styluses across the touchscreen and continuously recording touch events. Test result details are uploaded to the backend platform 118 for reference.

The system may include a camera testing feature that tests one or more cameras of a mobile device, such as the back and front cameras of the devices. This may be done by applying automatic picture analytics. The camera cell may also measure the wired charging current drain through USB-C, lightning, micro-USB ports, or the like, and compare the results to test limits for a binary, e.g., pass/fail, outcome. In aspect, the camera testing feature tests device hardware keys with physical actuators, wireless charging functionality, and gyroscope and accelerometer sensors.

The functionality of the camera testing feature may include automatically connecting devices to the appropriate port (USB-C, micro-USB, or lightning) based on the device type, e.g., model, to measure charging current consumption. The current drain may be compared to device type-specific limits to determine the result, e.g., the binary result. The mobile device may be moved to the key test position, where an arm moves the device to a key actuator that presses hardware keys and fetches mobile OS events to test their functionality.

In an aspect, the camera testing feature places the mobile device on a wireless charger for testing. In another aspect, the camera testing feature may rotate the device in a defined manner to stimulate the gyroscope and accelerometer sensors around axes, such as two or three axes of rotation, and read sensor values during the movements. The mobile device may be positioned with the back camera in front of a standardized test pattern illuminated with a light box, and a picture is taken and automatically analyzed for quality. This test may be repeated with the front camera, additional back cameras) before the unit is moved to the egress position and conveyed out. Test result details may be uploaded to the system for reference.

The system may include an audio testing feature configured to perform parametric tests on the test speaker and microphone audio components. In an aspect, the audio testing feature conducts parametric tests on mobile device headset audio functionality and tests the functionality of the device related to its function with headsets or similar peripherals, such as playing or recording audio through USB-C, Lightning or TRRS connectors. Analyses of audio signal level and quality may also be performed.

The audio testing feature may be configured to measure headset speaker and microphone, or other audio output component, audio levels or distortion levels. The measurement results may be uploaded for reference. In an aspect, the measurement results are compared to threshold values to make a binary decision, such as a pass/fail decision. Audio signals recorded during measurements may be uploaded. The audio testing feature may mimic headset buttons and check the resulting mobile device operating system events while connected to USB-C, lightning, TRRS, or other port. Device speakers may be parametrically tested for audio level and distortion, while device microphones may be tested for sensitivity and distortion. In an aspect, device speaker and microphone measurements are performed in audio chambers to avoid the impact of ambient operational noises. Measurement equipment may be mounted on shock absorbers to avoid interference from low-frequency vibrations, e.g., those through the operation floor.

The system may include a clearing feature. In an aspect, the clearing feature may perform USB testing. The cell may include a clearing feature configured to perform data wipes on various device types, such as iOS and Android devices, and verify the data wipe. The clearing feature may support multi-processing. In an example aspect, the clearing feature supports parallel multi-processing of up to 5 devices to maintain a defined takt time.

The clearing feature may perform functions such as plugging devices into USB-C, lightning, micro-USB, or the like ports or connections and carrying out a data wipe. In aspects, the wipe is verified, and the verification result is uploaded to the system for reference, e.g., by other systems of the mobile device processing system.

The processing system for automated processing of mobile devices may be customizable to individual customer requirements, which may include which measurements to perform and specific measurement thresholds. The use of automation ensures consistent, fast, and error-free testing. In an example, the cell is configured to process up to 30-50 units per hour (UPH) and support testing of a wide range of device sizes and testing scenarios.

The processing system may support testing of a wide range of device sizes and testing scenarios, including small form factor devices such as smartphones and larger form factor devices such as tablets. The flexibility to support a wide range of device sizes and testing scenarios may enable the processing system to accommodate diverse mobile device portfolios without requiring separate processing lines for different device categories. In an example, the processing system may support maximum device dimensions sufficient to accommodate tablets and similar devices (e.g., 330 mm by 211 mm in length and width), as well as all practical device thicknesses ranging from thin smartphones and tablets to thicker devices such as rugged mobile devices, devices with extended battery cases, or foldable devices in folded configurations.

The processing system may support 100% product mix across devices running a first mobile operating system and devices running a second mobile operating system without requiring changes to the processing line configuration. The processing system may automatically identify the operating system of each mobile device and apply appropriate testing procedures and communication protocols for the identified operating system. The 100% product mix support may include bar phones having a rectangular slab form factor, flip phones having a clamshell form factor where a display portion folds against a keypad or secondary display portion along a hinge axis, foldables having a foldable display that folds along a hinge axis, and tablets of various sizes up to 13 inches in diagonal display dimension. The 100% product mix support across bar phones, flip phones, foldables, and tablets may be provided without any retrofit, with the processing system accommodating the different form factors, sizes, and configurations through software configuration, adjustable fixtures, and universal handling mechanisms that adapt to different device characteristics.

In examples, the processing system may also support smartwatch testing with relatively minor additional features. The additional features for smartwatch testing may include a pairing jig with near-field RF communication configured to hold a smartwatch in position and establish wireless communication using protocols such as NFC or Bluetooth Low Energy. The additional features may also include a specific form shape of the device gripper configured to accommodate the smaller form factor of smartwatches, with smaller gripping surfaces, different gripping geometries, or specialized contact points that enable secure handling without damaging the watch housing, display, or band attachment points. The processing system may also support laptop computer testing as a variant configuration that adapts the inspection and testing capabilities to accommodate the larger form factor, different interface characteristics, and different operating system of laptop computers.

For cosmetic inspection of tablets, the processing system may take several pictures of the surfaces to capture image data covering the entire surface area despite the larger dimensions of the tablet form factor. The several pictures taken of tablet surfaces may be stitched together automatically for cosmetic analytics, with the stitching process aligning the pictures based on overlapping regions or reference features and blending them together to create a seamless composite image. The composite image created through automatic stitching may be analyzed using the same cosmetic analytics algorithms applied to single images of smaller devices, enabling consistent defect detection and grading across devices of different sizes.

Having described an overview of some embodiments of the present technology, an example computing environment in which embodiments of the present technology may be implemented is described below in order to provide a general context for various aspects of the present technology. Operations of the mobile device processing system may be performed by a computing device, such as computing device 500.

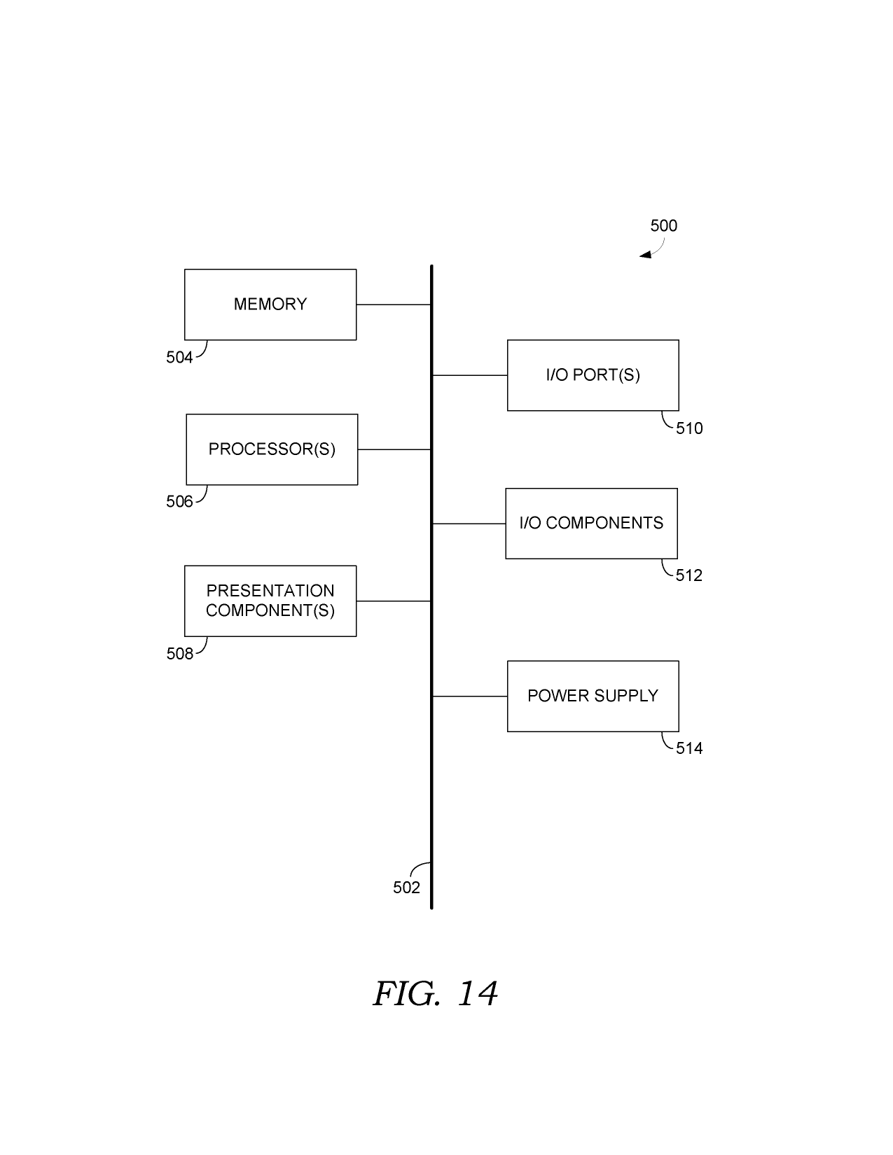

Referring now to FIG. 14, an example operating environment for implementing embodiments of the present technology is shown and designated generally as computing device 500. Computing device 500 is but one example of a suitable computing environment and is not intended to suggest any limitation as to the scope of use or functionality of the technology. Computing device 500 should not be interpreted as having any dependency or requirement relating to any one or combination of components illustrated.

The technology may be described in the general context of computer code or machine-useable instructions, including computer-executable instructions, such as program modules, being executed by a computer or other machine, such as a cellular telephone, personal data assistant, or other handheld device. Generally, program modules, including routines, programs, objects, components, data structures, etc., refer to code that performs particular tasks or implements particular abstract data types. The technology may be practiced in a variety of system configurations, including handheld devices, consumer electronics, general-purpose computers, more specialty computing devices, etc. The technology may also be practiced in distributed computing environments where tasks are performed by remote-processing devices that are linked through a communications network.

With reference to FIG. 14, computing device 500 includes bus 502, which directly or indirectly couples the following devices: memory 504, one or more processors 506, one or more presentation components 508, input/output (I/O) ports 510, input/output components 512, and illustrative power supply 514. Bus 502 represents what may be one or more buses (such as an address bus, data bus, or combination thereof). Although the various blocks of FIG. 2 are shown with lines for the sake of clarity, in reality, delineating various components is not so clear, and metaphorically, the lines would more accurately be grey and fuzzy. For example, one may consider a presentation component, such as a display device, to be an I/O component. Also, processors have memory. The inventors recognize that such is the nature of the art, and reiterate that the diagram of FIG. 14 is merely illustrative of an example computing device that can be used in connection with one or more embodiments of the present technology. Distinction is not made between such categories as “workstation,” “server,” “laptop,” “handheld device,” etc., as all are contemplated within the scope of FIG. 14 and with reference to “computing device.”

Computing device 500 typically includes a variety of computer-readable media. Computer-readable media can be any available media that can be accessed by computing device 500 and includes both volatile and non-volatile media, and removable and non-removable media. By way of example, and not limitation, computer-readable media may comprise computer storage media and communication media. Computer storage media, also referred to as a communication component, includes both volatile and non-volatile, removable and non-removable media implemented in any method or technology for storage of information, such as computer-readable instructions, data structures, program modules, or other data. Computer storage media includes, but is not limited to, RAM, ROM, EEPROM, flash memory, or other memory technology; CD-ROM, digital versatile disks (DVDs), or other optical disk storage; magnetic cassettes, magnetic tape, magnetic disk storage, or other magnetic storage devices; or any other medium that can be used to store the desired information and that can be accessed by computing device 500. Computer storage media does not comprise signals per se.

Communication media typically embodies computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 504 includes computer storage media in the form of volatile or non-volatile memory. The memory may be removable, non-removable, or a combination thereof. Example hardware devices include solid-state memory, hard drives, optical-disc drives, etc. Computing device 500 includes one or more processors that read data from various entities, such as memory 504 or I/O components 512. Presentation component(s) 508 presents data indications to a user or other device. Example presentation components include a display device, speaker, printing component, vibrating component, etc.

I/O ports 510 allow computing device 500 to be logically coupled to other devices, including I/O components 512, some of which may be built-in. Illustrative components include a microphone, joystick, game pad, satellite dish, scanner, printer, wireless device, etc. The I/O components 512 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition, both on screen and adjacent to the screen, as well as air gestures, head and eye tracking, or touch recognition associated with a display of computing device 500. Computing device 500 may be equipped with depth cameras, such as stereoscopic camera systems, infrared camera systems, RGB (red-green-blue) camera systems, touchscreen technology, other like systems, or combinations of these, for gesture detection and recognition. Additionally, the computing device 500 may be equipped with accelerometers or gyroscopes that enable detection of motion. The output of the accelerometers or gyroscopes may be provided to the display of computing device 500 to render immersive augmented reality or virtual reality. Power supply 514 may supply power to 100 or components thereof.

At a low level, hardware processors execute instructions selected from a machine language (also referred to as machine code or native) instruction set for a given processor. The processor recognizes the native instructions and performs corresponding low-level functions relating, for example, to logic, control, and memory operations. Low-level software written in machine code can provide more complex functionality to higher levels of software. As used herein, computer-executable instructions includes any software, including low-level software written in machine code; higher-level software, such as application software; and any combination thereof. Any other variations and combinations thereof are contemplated within embodiments of the present technology.

Referring to the drawings and description in general, having identified various components in the present disclosure, it should be understood that any number of components and arrangements might be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, or software. For instance, various functions may be carried out by a processor executing instructions stored in memory. As such, other arrangements and elements (e.g., machines, interfaces, functions, orders, and groupings of functions, etc.) can be used in addition to or instead of those shown.

### The following examples pertain to further embodiments.

Clause 1: A system for measuring vibrations from a mobile device, comprising: a panel comprising a cutout; a membrane stretched across the cutout, the membrane comprising a first face and an opposing second face, wherein the second face is configured for receiving the mobile device; and a sensor attached to the first face of the membrane, wherein the sensor is configured to detect vibrations transmitted through the membrane when the mobile device vibrates.

Clause 2: Clause 1, further comprising a structure in which the panel is encapsulated.

Clause 3: Clause 2, wherein the structure comprises a cabinet structure, and wherein the panel is slidably inserted and removed from the cabinet structure.

Clause 4: Clause 3, wherein the panel is connected to a door that forms part of the structure when the panel is inserted into the structure.

Clause 5: Any of Clauses 1-4, wherein the cutout comprises a surface area greater than a surface area of the mobile device.

Clause 6: Any of Clauses 1-5, wherein the sensor is a piezo sensor.

Clause 7: Any of Clauses 1-5, wherein the sensor is an accelerometer.

Clause 8: Any of Clauses 1-7, wherein the sensor is connected to a computing device via a data port.

Clause 9: Clause 8, wherein the data port is a USB port that provides data communication and power supply to the sensor.

Clause 10: Any of Clauses 1-9, wherein the membrane comprises an extensible material.

Clause 11: Any of Clauses 1-10, wherein the system is part of an automated mobile device processing system configured to perform inspection and testing operations on mobile devices.

Clause 12: A non-transitory computer-readable medium storing instructions that, when executed by a processor, cause the processor to perform operations comprising: receiving, from a sensor attached to a first face of a membrane stretched across a cutout in a panel, a signal indicative of vibrations transmitted through the membrane from a mobile device disposed on a second face of the membrane opposing the first face; and determining, based on the signal, a relative operational efficacy of a vibratory apparatus within the mobile device.

Clause 13: Clause 12, wherein the operations further comprise comparing the relative operational efficacy to a threshold value to determine whether the vibratory apparatus passes or fails a functionality test.

Clause 14: Clause 13, wherein the threshold value is device type-specific.

Clause 15: Any of Clauses 12-14, wherein the sensor is a piezo sensor or an accelerometer.

Clause 16: Any of Clauses 12-15, wherein the membrane isolates the sensor from ambient vibrations generated by equipment external to the mobile device.

Clause 17: A method for measuring vibrations from a mobile device, comprising: positioning the mobile device on a membrane stretched across a cutout in a panel, wherein a sensor is attached to an underside of the membrane; causing the mobile device to vibrate; measuring, via the sensor, a force applied to the membrane caused by the vibration of the mobile device; and determining a relative operational efficacy of a vibratory apparatus within the mobile device based on the measured force.

Clause 18: Clause 17, wherein the sensor is a piezo sensor or an accelerometer.

Clause 19: Any of Clauses 17-18, wherein the membrane isolates the sensor from ambient vibrations generated by equipment external to the mobile device.

Clause 20: Any of Clauses 17-19, further comprising comparing the relative operational efficacy to a threshold value to determine whether the vibratory apparatus passes or fails a functionality test.

Clause 21: An automated mobile device processing system comprising a plurality of features to perform a plurality of tasks on a mobile device passing through the system, the system comprising: a conveyor for transporting the mobile device through the system; a cosmetic inspection feature comprising an imaging and artificial intelligence (AI)-based defect detection feature for inspecting the mobile device as the mobile device is within the system; and a display inspection feature, the display inspection feature inspecting a display of the mobile device while the display is in an on-configuration, the display inspection feature comprising a touch element and configured to move the touch element relative to the display of the mobile device using an input pattern that is recognized by an application executed on the mobile device.

Clause 22: Clause 21, wherein the cosmetic inspection feature further comprises an area camera or line camera, the area camera or line camera capturing images of the mobile device under varying lighting conditions while the mobile device is in the system.

Clause 23: Any of Clauses 21-22, wherein the AI-based defect detection feature comprises a machine learning model trained on different surface types for mobile devices.

Clause 24: Any of Clauses 21-23, wherein the AI-based defect detection feature identifies a scratch location based on light diffraction from a surface of the mobile device.

Clause 25: Any of Clauses 21-24, wherein the cosmetic inspection feature comprises a plurality of static lighting components aligned along a movement path of the mobile device within the system, such that one or more imaging devices is configured to image the mobile device under various lighting conditions while the mobile device is in motion along the movement path.

Clause 26: Any of Clauses 21-25, wherein the AI-based defect detection feature comprises a plurality of machine learning models, each machine learning model trained on a different surface type.

Clause 27: Any of Clauses 21-26, wherein the AI-based defect detection feature comprises a machine learning model configured to determine a surface type of the mobile device.

Clause 28: Any of Clauses 21-27, wherein the system comprises an acoustic sensor and an acoustic stylus, wherein the acoustic stylus is configured to contact a scratch on the mobile device, and the acoustic sensor is configured to detect a sound emitted from the acoustic stylus when contacting the scratch, and wherein the sound indicates a depth of the scratch.

Clause 29: Any of Clauses 21-28, wherein the system communicates a status of the mobile device based on an optical code displayed on the display of the mobile device.

Clause 30: Any of Clauses 21-29, wherein the system is configured to hold a certain number of mobile devices, and the number of mobile devices the system is configured to hold is dependent upon an amount of time it takes for the plurality of features to perform their specific tasks.

Clause 31: Any of Clauses 21-30, wherein the cosmetic inspection feature is configured to generate and display a composite image representative of the mobile device, the composite image indicating the detected defects.

Clause 32: Clause 31, wherein the detected defects are visually indicated within the composite image.

Clause 33: Clause 32, wherein the visual indications within the composite image indicating the detected defects are selectable to view metadata associated with the detected defects.

Clause 34: Clause 33, wherein the metadata includes one or more of location, reflectivity, or contrast ratio.

Clause 35: Any of Clauses 33-34, wherein the metadata includes one or more of depth of scratch or surface type where the scratch is located.

Clause 36: Any of Clauses 21-35, wherein the detected defects comprise a scratch pattern.

Clause 37: Any of Clauses 21-36, further comprising a wired communication feature, the wired communication feature comprising: a plurality of USB receiving sites for accepting a plurality of mobile devices and establishing electronic communication with the mobile devices; one or more low-resolution imaging devices positioned to receive light emitted from displays of the mobile devices; and one or more processors configured to: switch USB modes while the mobile devices are connected via USB ports; and determine, via image data captured using the one or more low-resolution imaging devices, whether the mobile devices respond according to a programmed action performed on the mobile device through the communication with the USB ports.

Clause 38: Clause 37, wherein the USB modes comprise a charging mode and a data mode.

Clause 39: Clause 38, wherein the USB modes comprise a debug mode.

Clause 40: An inspection and testing cell for processing mobile devices, comprising: a housing; a conveyor segment integrated within the housing and extending outwardly from the housing, the conveyor segment configured to transport mobile devices into and out of the inspection and testing cell; a robot arm disposed within the housing and configured to pick up a mobile device from the conveyor segment and maneuver the mobile device to testing equipment within the housing; and a cell controller configured to coordinate operations of the robot arm and the conveyor segment.

Clause 41: Clause 40, wherein the conveyor segment is independently operable from conveyor segments of adjacent inspection and testing cells.

Clause 42: Any of Clauses 40-41, wherein the housing comprises a top section, a center section, and a bottom section, and wherein the robot arm is disposed within the center section.

Clause 43: Any of Clauses 40-42, wherein the robot arm is a 6-axis robot arm.

Clause 44: Any of Clauses 40-43, further comprising a status indicator disposed on an upper surface of the housing.

Clause 45: Any of Clauses 40-44, wherein the inspection and testing cell is mounted on lockable wheels for repositioning within a device processing line.

Clause 46: Any of Clauses 40-45, wherein the conveyor segment includes a conveyor drive motor configured to provide motive force for transporting mobile devices along the conveyor segment.

Clause 47: Any of Clauses 40-46, further comprising one or more testing modules selected from a cosmetic inspection module, a touch screen inspection module, a camera inspection module, an audio inspection module, a wired communication module, and a vibration testing module.

Clause 48: Clause 47, wherein the robot arm is configured to pick up a mobile device from a device pick position on the conveyor segment, maneuver the mobile device to one or more of the testing modules, and place the mobile device back onto the conveyor segment at an egress position.

Clause 49: Any of Clauses 40-48, wherein the inspection and testing cell is configured to handle multiple mobile devices simultaneously by positioning mobile devices at different testing modules for parallel inspection and testing operations.

Clause 50: Any of Clauses 40-49, wherein the conveyor segment of the inspection and testing cell is aligned end-to-end with conveyor segments of adjacent inspection and testing cells to form a continuous conveyance path through a device processing line.

Clause 51: A camera inspection apparatus for testing cameras of a mobile device, comprising: a first light source configured to emit light in a first direction; a second light source positioned substantially opposite the first light source and configured to emit light in a second direction opposite the first direction; and a camera test pattern positioned to be captured by one or more cameras of the mobile device, the camera test pattern comprising a contrast-rich geometrical shape for testing auto focus functionality of the mobile device.

Clause 52: Clause 51, wherein the first light source and the second light source emit visible light, infrared light, or ultraviolet light.

Clause 53: Any of Clauses 51-52, wherein the first light source and the second light source are positioned along a common theoretical plane.

Clause 54: Any of Clauses 51-52, wherein the first light source and the second light source are offset such that light emitted from the first light source travels along a different theoretical plane than light emitted from the second light source.

Clause 55: Any of Clauses 51-54, further comprising a light box providing controlled illumination of the camera test pattern.

Clause 56: Any of Clauses 51-55, wherein the camera inspection apparatus is configured to test a front aspect camera and a rear aspect camera of the mobile device.

Clause 57: Any of Clauses 51-56, wherein the camera inspection apparatus analyzes captured images for focus accuracy, color balance, exposure, noise levels, and image sharpness.

Clause 58: Any of Clauses 51-57, wherein the camera test pattern is used for testing geometric distortion and perspective distortion in images captured by the one or more cameras.

Clause 59: An audio inspection apparatus for testing audio components of a mobile device, comprising: an isolated sound chamber configured to attenuate ambient sounds; a speaker disposed within the isolated sound chamber and configured to emit sounds at frequencies detectable by a microphone of the mobile device; and a microphone disposed within the isolated sound chamber and configured to detect sounds emitted by a speaker of the mobile device.

Clause 60: Clause 59, wherein the audio inspection apparatus tests frequencies up to 20 kHz.

Clause 61: Any of Clauses 59-60, wherein the audio inspection apparatus tests sound volumes up to 115 dB.

Clause 62: Any of Clauses 59-61, wherein the audio inspection apparatus tests headset audio functionality through USB-C, Lightning, or TRRS connectors.

Clause 63: Any of Clauses 59-62, wherein the audio inspection apparatus measures audio levels and distortion levels.

Clause 64: Any of Clauses 59-63, wherein the audio inspection apparatus mimics headset buttons and checks resulting operating system events of the mobile device.

Clause 65: Any of Clauses 59-64, wherein measurement equipment of the audio inspection apparatus is mounted on shock absorbers to avoid interference from low-frequency vibrations.

Clause 66: A wired communication apparatus for testing port functionality of a mobile device, comprising: a plurality of USB receiving sites configured to accept a plurality of mobile devices and establish electronic communication with the mobile devices; a USB controller comprising a printed circuit board configured to provide software-controlled switching between different USB modes without unplugging the mobile device; and one or more low-resolution imaging devices positioned to capture outputs displayed on displays of the mobile devices.

Clause 67: Clause 66, wherein the USB modes include a charging mode, a data mode, and a debug mode.

Clause 68: Any of Clauses 66-67, wherein the printed circuit board allows for full bandwidth charging when configured in charging mode and full bandwidth data transfer when configured in data mode.

Clause 69: Any of Clauses 66-68, wherein the printed circuit board serves as an injection vector for a keyboard or mouse to instruct the mobile device.

Clause 70: Any of Clauses 66-69, wherein the printed circuit board intercepts display output using USB DisplayLink Protocol for devices that support HDMI output.

Clause 71: Any of Clauses 66-70, wherein the wired communication apparatus utilizes touch injection over USB to activate developer mode on the mobile device.

Clause 72: Any of Clauses 66-71, wherein the one or more low-resolution imaging devices capture images at a resolution of 60 to 150 PPI.

Clause 73: A touch screen inspection apparatus for testing display and touch functionality of a mobile device, comprising: an imaging device configured to capture light from a display of the mobile device when the display is in an on-configuration; and a touch element configured to move across the display of the mobile device using an input pattern recognized by an application executed on the mobile device.

Clause 74: Clause 73, wherein the input pattern comprises two diagonal movements across the display from corner to corner and a movement along each perimeter edge of the display.

Clause 75: Any of Clauses 73-74, wherein the touch element comprises two or more touch surfaces for multi-touch testing including pinching, pulling, and multi-touch directional movement.

Clause 76: Any of Clauses 73-75, wherein the touch element is a specialized stylus configured to interact with a particular type of mobile device.

Clause 77: Any of Clauses 73-76, wherein the touch screen inspection apparatus moves the touch element using a preset touch force and a preset stylus speed.

Clause 78: Any of Clauses 73-77, wherein the touch screen inspection apparatus generates a composite image combining outputs of a cosmetic inspection feature and the touch screen inspection apparatus.

Clause 79: Any of Clauses 73-78, wherein the touch screen inspection apparatus is configured to test flat displays, curved displays, and edged displays.

Clause 80: Any of Clauses 73-79, wherein the touch screen inspection apparatus utilizes product-specific test patterns.

Clause 81: A cosmetic inspection apparatus for identifying physical defects on a mobile device, comprising: one or more imaging devices configured to capture images of the mobile device under varying lighting conditions; a plurality of lighting components configured to provide different lighting conditions; and an AI-based defect detection feature comprising one or more machine learning models trained to identify defects on mobile device surfaces.

Clause 82: Clause 81, wherein the plurality of lighting components provide lighting conditions including simulated daylight, low light, diffuse light, directional light, colored light, strobe light, polarized light, infrared light, and ultraviolet light.

Clause 83: Any of Clauses 81-82, wherein the one or more machine learning models include models trained on different surface types including glass, metal, plastic, ceramic, and carbon fiber.

Clause 84: Any of Clauses 81-83, further comprising an acoustic stylus and an acoustic sensor for determining a depth of a scratch on the mobile device.

Clause 85: Any of Clauses 81-84, wherein the cosmetic inspection apparatus is configured to test all six sides of the mobile device including edges of each side.

Clause 86: Any of Clauses 81-85, wherein the cosmetic inspection apparatus identifies scratch patterns and sorts mobile devices into categories based on the scratch patterns.

Clause 87: Any of Clauses 81-86, wherein the AI-based defect detection feature identifies a scratch location based on light diffraction from a surface of the mobile device.

Clause 88: A flip and fold testing apparatus for testing flip devices and foldable devices, comprising: a universal jig configured to support different form shapes of flip devices and foldable devices; a mechanism configured to actively open and close a device lid in a defined manner; a force sensor configured to measure force applied during lid opening and closing operations; and a microphone configured to detect sounds generated by a hinge mechanism during lid opening and closing operations.

Clause 89: Clause 88, wherein the flip and fold testing apparatus performs acoustic detection of lid opening and closing defects.

Clause 90: Any of Clauses 88-89, wherein the flip and fold testing apparatus positions devices with a center of a hinge aligned with a rotation axis of the mechanism.

Clause 91: Any of Clauses 88-90, wherein the flip and fold testing apparatus tests hinge position sensors that detect an angle of the device lid.

Clause 92: Any of Clauses 88-91, wherein the flip and fold testing apparatus tests display functionality when the device is in open and closed configurations.

Clause 93: An active stylus testing apparatus for testing an active stylus associated with a mobile device, comprising: a stylus jig configured to receive a mobile device having an active stylus inserted therein; a stylus extraction mechanism configured to release and extract the active stylus from the mobile device; a stylus holder configured to hold the extracted active stylus in a testing position; and a stylus insertion mechanism configured to reinsert the active stylus into the mobile device after testing.

Clause 94: Clause 93, wherein the stylus extraction mechanism includes a hook mechanism for gripping the active stylus.

Clause 95: Any of Clauses 93-94, wherein a robot arm guides the mobile device to the stylus jig.

Clause 96: Any of Clauses 93-95, wherein the active stylus testing apparatus tests pressure sensitivity of the active stylus.

Clause 97: Any of Clauses 93-96, wherein the active stylus testing apparatus tests tilt detection of the active stylus.

Clause 98: Any of Clauses 93-97, wherein the active stylus testing apparatus tests buttons on the active stylus.

Clause 99: Any of Clauses 93-98, wherein the active stylus testing apparatus tests touchscreen functionality with the active stylus.

Clause 100: Any of Clauses 93-99, wherein the active stylus testing apparatus tests the touchscreen twice, once with a capacitive stylus and once with the active stylus for devices that support active styluses.

Clause 101: A load manager system for managing a plurality of inspection and testing cells arranged in a multi-cell configuration, comprising: a plurality of inspection and testing cells, each cell having an independently operable conveyor segment; and a load manager software instance configured to monitor devices entering the multi-cell configuration and distribute the devices to individual cells, wherein the load manager software instance is configured to control stop-and-go operation of individual conveyor segments to efficiently process devices from an ingress point to an egress point.

Clause 102: Clause 101, wherein the load manager prevents double testing by tracking which tests have been performed on each device.

Clause 103: Any of Clauses 101-102, wherein the load manager balances system utilization to ensure equal wear across cells for minimized maintenance.

Clause 104: Any of Clauses 101-103, wherein the load manager routes devices to cells with specialized equipment.

Clause 105: Any of Clauses 101-104, wherein the load manager feeds additional devices to specialized cells when the specialized cells are not fully utilized.

Clause 106: Any of Clauses 101-105, wherein the load manager performs real-time monitoring of cell configuration and operation status.

Clause 107: Any of Clauses 101-106, wherein the load manager system provides automatic management to optimize performance and work around technical issues.

Clause 108: Any of Clauses 101-107, wherein the load manager system provides redundancy where a second cell automatically performs functions when a first cell stops functioning.

Clause 109: A universal mobile device processing system configured to process a plurality of different device types without system retrofit, comprising: a housing; a robot arm disposed within the housing and configured to handle mobile devices of different form factors; a conveyor segment configured to transport mobile devices of different sizes; and one or more testing modules configured to test mobile devices of different device types, wherein the universal mobile device processing system is configured to process bar phones, flip phones, foldable phones, and tablets in a product mix without mechanical retrofitting, manual re-configuration, or software re-configuration.

Clause 110: Clause 109, wherein the universal mobile device processing system supports device dimensions up to 330 mm by 211 mm.

Clause 111: Any of Clauses 109-110, wherein the universal mobile device processing system supports devices running a first mobile operating system and devices running a second mobile operating system.

Clause 112: Any of Clauses 109-111, wherein the universal mobile device processing system performs automatic device identification to determine device type.

Clause 113: Any of Clauses 109-112, wherein the universal mobile device processing system applies device-specific test parameters based on identified device type.

Clause 114: Any of Clauses 109-113, wherein the universal mobile device processing system includes universal jigs configured to accommodate different device form factors.

Clause 115: A secure communication gateway for managing communications between a mobile device processing system and a backend platform, comprising: a gateway device disposed at a client site and configured to communicate with the backend platform, wherein the gateway device is configured to orchestrate test sequences between the mobile device processing system and a mobile device test application without exposing test sequence details to the mobile device processing system, and wherein the gateway device is configured to manage secure access to the backend platform without exposing proprietary access information to the mobile device processing system.

Clause 116: Clause 115, wherein the gateway device has an Ethernet connection to the mobile device processing system.

Clause 117: Any of Clauses 115-116, wherein the gateway device has a WiFi connection to the mobile device test application.

Clause 118: Any of Clauses 115-117, wherein the gateway device receives test data from the mobile device processing system and uploads the test data to the backend platform.

Clause 119: Any of Clauses 115-118, wherein the gateway device receives test results from the backend platform and provides the test results to a customer system.

Clause 120: Any of Clauses 115-119, wherein the gateway device exposes an API for controlled functionality access.

Clause 121: Any of Clauses 115-120, wherein the gateway device prevents test systems from directly communicating with the backend platform.

Clause 122: Any of Clauses 1-11, wherein the membrane is constructed from polyurethane film, thermoplastic elastomer, neoprene, EPDM rubber, natural latex, polyethylene terephthalate film, or polyimide film.

Clause 123: Any of Clauses 1-11, wherein the membrane has a thickness ranging from approximately 0.1 mm to 2.0 mm.

Clause 124: Any of Clauses 1-11, wherein the membrane incorporates reinforcing fibers or mesh to enhance tear resistance while maintaining flexibility.

Clause 125: Any of Clauses 1-11, wherein the membrane is constructed as a multi-layer laminate combining different materials.

Clause 126: Any of Clauses 1-11, wherein the sensor is mechanically clamped to the membrane using a frame or bracket system that applies uniform pressure.

Clause 127: Any of Clauses 1-11, wherein the sensor is embedded within the membrane material during manufacturing.

Clause 128: Any of Clauses 1-11, wherein the sensor is attached using heat-bonding techniques.

Clause 129: Any of Clauses 1-11, wherein the sensor is mounted in a removable housing that clips or snaps onto the membrane.

Clause 130: Any of Clauses 1-11, wherein the sensor is attached using magnetic attachment where a ferromagnetic plate is bonded to the membrane and the sensor housing incorporates magnets.

Clause 131: Any of Clauses 1-11, wherein multiple sensors are distributed across the membrane surface at different positions to capture vibration characteristics from various contact points with the mobile device.

Clause 132: Any of Clauses 1-11, wherein the sensor is positioned off-center to align with a typical location of vibrator motors in mobile devices.

Clause 133: Any of Clauses 1-11, wherein an array of smaller sensors is arranged in a grid pattern across the membrane to provide spatial resolution of vibration intensity.

Clause 134: Any of Clauses 1-11, wherein the sensor positioning is adjustable via a sliding track or rail system beneath the membrane to accommodate different device sizes and vibrator locations.

Clause 135: Any of Clauses 40-50, wherein the conveyor segment is constructed from polyurethane, PVC, silicone rubber, neoprene, or fabric-reinforced rubber compounds.

Clause 136: Any of Clauses 40-50, wherein the conveyor segment incorporates anti-static properties to prevent electrostatic discharge damage to mobile devices.

Clause 137: Any of Clauses 40-50, wherein the conveyor segment features textured surfaces, raised ridges, or recessed channels to maintain device positioning during transport.

Clause 138: Any of Clauses 40-50, wherein the conveyor segment has a width varying from approximately 150 mm to 400 mm to accommodate different device sizes.

Clause 139: Any of Clauses 40-50, wherein the conveyor segment employs modular plastic belt segments that interlock, facilitating section replacement without full belt replacement.

Clause 140: Any of Clauses 81-87, wherein the cosmetic inspection apparatus employs ring lights positioned around imaging devices to provide uniform illumination.

Clause 141: Any of Clauses 81-87, wherein the cosmetic inspection apparatus employs articulated lighting arms that enable dynamic repositioning of light sources during inspection.

Clause 142: Any of Clauses 81-87, wherein the cosmetic inspection apparatus employs fiber optic light guides to deliver illumination to specific inspection zones.

Clause 143: Any of Clauses 81-87, wherein the cosmetic inspection apparatus incorporates tunable LED arrays capable of adjusting color temperature continuously across a range from 2700K to 6500K.

Clause 144: Any of Clauses 81-87, wherein the cosmetic inspection apparatus employs structured light projectors that cast patterns onto device surfaces to enhance detection of surface irregularities through shadow analysis.

Clause 145: Any of Clauses 81-87, wherein the cosmetic inspection apparatus employs coaxial lighting systems where light is directed along the same axis as the camera to minimize shadows on reflective surfaces.

Clause 146: Any of Clauses 1-11, wherein the chamber walls are lined with acoustic foam, mass-loaded vinyl, or multi-layer damping materials.

Clause 147: Any of Clauses 1-11, wherein the chamber employs a double-wall construction with an air gap or vibration-damping material between walls.

Clause 148: Any of Clauses 1-11, wherein pneumatic or hydraulic isolation mounts suspend the chamber to decouple it from floor vibrations.

Clause 149: Any of Clauses 1-11, wherein the chamber door or drawer mechanism incorporates labyrinth seals or magnetic seals to prevent acoustic leakage.

Clause 150: Any of Clauses 1-11, wherein active noise cancellation systems are integrated to counteract ambient noise within the testing frequency range.

Clause 151: Any of Clauses 66-72, wherein the USB ports are mounted on articulating arms or gantries that automatically position to align with device ports.

Clause 152: Any of Clauses 66-72, wherein the wired communication apparatus includes universal port adapters that accommodate USB-C, Lightning, micro-USB, and USB-A connections within a single receiving site.

Clause 153: Any of Clauses 66-72, wherein wireless charging pads are integrated adjacent to USB ports to enable simultaneous wired data communication and wireless charging testing.

Clause 154: Any of Clauses 66-72, wherein the USB receiving sites incorporate spring-loaded or pneumatically actuated connectors that automatically engage with device ports when devices are positioned.

Clause 155: Any of Clauses 40-50, wherein the robot arm employs vacuum suction cups as an alternative to mechanical grippers, with single or multiple suction points.

Clause 156: Any of Clauses 40-50, wherein the robot arm employs soft robotic grippers constructed from compliant materials that conform to irregular device shapes.

Clause 157: Any of Clauses 40-50, wherein the robot arm gripper incorporates force-sensing capabilities to prevent excessive pressure on devices.

Clause 158: Any of Clauses 40-50, wherein interchangeable gripper heads are stored within the cell and automatically swapped based on device type identification.

Clause 159: Any of Clauses 40-50, wherein the robot arm gripper includes integrated cameras or sensors to verify proper device engagement before movement.

Clause 160: Any of Clauses 101-108, wherein adjacent cells are connected through transfer plates or bridges that span gaps between cells to facilitate smooth device handoff.

Clause 161: Any of Clauses 101-108, wherein pneumatic or mechanical pusher mechanisms actively transfer devices between conveyors.

Clause 162: Any of Clauses 101-108, wherein gravity-assisted transfer ramps are employed where cells are positioned at slight elevation differences.

Clause 163: Any of Clauses 101-108, wherein robotic transfer arms positioned between cells pick devices from one conveyor and place them on the next.

Clause 164: Any of Clauses 101-108, wherein magnetic or air-bearing transfer systems enable contactless device movement between cells.

Clause 165: Any of Clauses 21-39, wherein RFID readers detect tags applied to devices for device identification.

Clause 166: Any of Clauses 21-39, wherein NFC communication reads device identifiers directly from device hardware.

Clause 167: Any of Clauses 21-39, wherein optical character recognition reads serial numbers or IMEI labels on device exteriors.

Clause 168: Any of Clauses 21-39, wherein machine vision systems identify device models based on physical characteristics such as camera arrangement, button placement, or overall dimensions.

Clause 169: Any of Clauses 21-39, wherein acoustic fingerprinting identifies devices based on unique audio response characteristics when stimulated with test tones.

Clause 170: Any of Clauses 73-80, wherein multiple independently actuated styluses simultaneously test multi-touch functionality.

Clause 171: Any of Clauses 73-80, wherein the touch element incorporates conductive foam or fabric pads that simulate finger contact.

Clause 172: Any of Clauses 73-80, wherein capacitive touch simulation is achieved through electrode arrays that generate electric fields without physical contact.

Clause 173: Any of Clauses 73-80, wherein the touch element includes pressure sensors to verify consistent contact force across the display surface.

Clause 174: Any of Clauses 73-80, wherein heated touch elements test touchscreen responsiveness under varying temperature conditions.

Clause 175: Any of Clauses 51-58, wherein integrating spheres provide perfectly diffuse illumination for uniform lighting tests.

Clause 176: Any of Clauses 51-58, wherein programmable LED panels display dynamic test patterns directly rather than illuminating separate test charts.

Clause 177: Any of Clauses 51-58, wherein the light boxes include motorized test chart holders that automatically position different charts for various tests.

Clause 178: Any of Clauses 51-58, wherein variable neutral density filters enable testing across a wide range of illumination levels.

Clause 179: Any of Clauses 51-58, wherein the light boxes incorporate color calibration targets that are automatically verified against reference standards.

Clause 180: Any of Clauses 21-39, wherein vibration sensors on robot arm joints detect bearing wear.

Clause 181: Any of Clauses 21-39, wherein current sensors on motors identify degradation before failure.

Clause 182: Any of Clauses 21-39, wherein thermal imaging cameras monitor component temperatures.

Clause 183: Any of Clauses 21-39, wherein acoustic sensors detect unusual sounds indicating mechanical issues.

Clause 184: Any of Clauses 21-39, wherein particle counters monitor air quality within the cell to predict filter replacement needs.

Clause 185: Any of Clauses 21-39, wherein optical sensors monitor belt wear by detecting surface degradation or tracking marks.

Clause 186: Any of Clauses 101-108, wherein the load manager operates as a distributed system with instances running on each cell that coordinate peer-to-peer.

Clause 187: Any of Clauses 101-108, wherein cloud-based load management enables remote monitoring and optimization across multiple facility locations.

Clause 188: Any of Clauses 101-108, wherein machine learning algorithms optimize device routing based on historical processing time data for different device types.

Clause 189: Any of Clauses 101-108, wherein the load manager incorporates digital twin simulations to predict throughput impacts of various routing decisions before implementation.

Clause 190: Any of Clauses 101-108, wherein real-time optimization algorithms continuously adjust routing based on current cell utilization and queue depths.

Clause 191: Any of Clauses 40-50, wherein HEPA filtration systems maintain air cleanliness for cosmetic inspection accuracy.

Clause 192: Any of Clauses 40-50, wherein temperature control systems maintain cells within specified ranges for consistent electronic testing.

Clause 193: Any of Clauses 40-50, wherein humidity control prevents condensation on devices and testing equipment.

Clause 194: Any of Clauses 40-50, wherein positive pressure systems prevent dust ingress during door openings.

Clause 195: Any of Clauses 40-50, wherein ionization systems neutralize static charges that could affect sensitive measurements or attract dust to device surfaces.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the words “including,” “having,” and other like words and their derivatives have the same broad meaning as the word “comprising,” and the word “accessing” comprises “receiving,” “referencing,” or “retrieving,” or derivatives thereof. Further, the word “communicating” has the same broad meaning as the word “receiving” or “transmitting,” as facilitated by software or hardware-based buses, receivers, or transmitters using communication media described herein.

In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

As further used herein, the term “train," when referring to training a machine learning model, may mean training an untrained model, further training a previously trained model, fine-tuning a pretrained model, or the like. “Train” is intended to broadly cover methods of machine learning using a dataset.

For purposes of a detailed discussion above, embodiments of the present technology are described with reference to a distributed computing environment. However, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present technology may generally refer to the distributed data object management system and the schematics described herein, it is understood that the techniques described may be extended to other implementation contexts.

From the foregoing, it will be seen that this technology is one well-adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated by the accompanying drawings is to be interpreted as illustrative and not in a limiting sense.

What is claimed is:

1. A system for measuring vibrations from a mobile device, comprising:
a panel comprising a cutout;
a membrane stretched across the cutout, the membrane comprising a first face and an opposing second face, wherein the second face is configured for receiving the mobile device; and
a sensor attached to the first face of the membrane, wherein the sensor is configured to detect vibrations transmitted through the membrane when the mobile device vibrates.

2. The system of claim 1, further comprising a structure in which the panel is encapsulated.

3. The system of claim 2, wherein the structure comprises a cabinet structure, and wherein the panel is slidably inserted and removed from the cabinet structure.

4. The system of claim 3, wherein the panel is connected to a door that forms part of the structure when the panel is inserted into the structure.

5. The system of claim 1, wherein the cutout comprises a surface area greater than a surface area of the mobile device.

6. The system of claim 1, wherein the sensor is a piezo sensor.

7. The system of claim 1, wherein the sensor is an accelerometer.

8. The system of claim 1, wherein the sensor is connected to a computing device via a data port.

9. The system of claim 8, wherein the data port is a USB port that provides data communication and power supply to the sensor.

10. The system of claim 1, wherein the membrane comprises an extensible material.

11. The system of claim 1, wherein the system is part of an automated mobile device processing system configured to perform inspection and testing operations on mobile devices.

12. A non-transitory computer-readable medium storing instructions that, when executed by a processor, cause the processor to perform operations comprising:
receiving, from a sensor attached to a first face of a membrane stretched across a cutout in a panel, a signal indicative of vibrations transmitted through the membrane from a mobile device disposed on a second face of the membrane opposing the first face; and
determining, based on the signal, a relative operational efficacy of a vibratory apparatus within the mobile device.

13. The non-transitory computer-readable medium of claim 12, wherein the operations further comprise comparing the relative operational efficacy to a threshold value to determine whether the vibratory apparatus passes or fails a functionality test.

14. The non-transitory computer-readable medium of claim 13, wherein the threshold value is device type-specific.

15. The non-transitory computer-readable medium of claim 12, wherein the sensor is a piezo sensor or an accelerometer.

16. The non-transitory computer-readable medium of claim 12, wherein the membrane isolates the sensor from ambient vibrations generated by equipment external to the mobile device.

17. A method for measuring vibrations from a mobile device, comprising:
positioning the mobile device on a membrane stretched across a cutout in a panel, wherein a sensor is attached to an underside of the membrane;
causing the mobile device to vibrate;
measuring, via the sensor, a force applied to the membrane caused by the vibration of the mobile device; and
determining a relative operational efficacy of a vibratory apparatus within the mobile device based on the measured force.

18. The method of claim 17, wherein the sensor is a piezo sensor or an accelerometer.

19. The method of claim 17, wherein the membrane isolates the sensor from ambient vibrations generated by equipment external to the mobile device.

20. The method of claim 17, further comprising comparing the relative operational efficacy to a threshold value to determine whether the vibratory apparatus passes or fails a functionality test.
